(19) United States
(12) Patent Application Publication
(10) Pub. No.: US 2012/0203645 A1
(43) Pub. Date: Aug. 9, 2012

(54) COMPUTER-ENABLED METHOD AND SYSTEM FOR AUTOMATED APPLICATION, DETERMINATION AND DISTRIBUTION OF TAXES AND FEES ON THE SALE OF PRODUCTS FOR ANIMALS

(75) Inventors: DONALD C. SUTTER, TULSA, OK (US); KURT D. GREEN, PORTLAND, OR (US); THOMAS A. FRIAR, PORTLAND, OR (US); ANDREW J. BANE, PORTLAND, OR (US)

(73) Assignee: STRATEGIC PHARMACEUTICAL SOLUTIONS, INC., PORTLAND, OR (US)

(21) Appl. No.: 13/024,314

(22) Filed: Feb. 9, 2011

(51) Int. Cl. G06Q 20/00

(52) U.S. Cl. 705/19

(57) ABSTRACT

A computer-enabled method for dynamic, automated application of taxes to veterinary pharmaceutical and other animal-related product items for sale by a central product provider and subsequent recovery of historically accurate taxes as applied by the central product provider for automated tax crediting and distribution to veterinary hospitals for later remittance to taxing authorities. Member account details, per-item and per-invoice tax records are accessed, created and stored in computer memory, and during purchase an invoice record is created with a snapshot of an invoice ID, per-item base prices, per-item taxes and per-invoice taxes. After a sale is completed, including payment of the invoice with a customer's credit card wallet information, the invoice is retrieved and taxes on the invoice are automatically credited and distributed to various veterinary hospitals.

### BACKGROUND OF THE INVENTION

The present invention relates in general to applying taxes and other fees to veterinary products for subsequent payment of the taxes and fees to regulatory bodies upon sale of the products, and in particular to a computer-enabled method and system for automated, dynamic application of current taxes and other fees to veterinary products sold at point of sale terminals and via e-commerce methods together with automated determination, accounting and distribution of tax and other required fee amounts to animal hospitals and veterinarians for remitting to taxing authorities and regulatory bodies.

Traditionally, pharmacy's within veterinary hospitals, and especially those within smaller animal treatment facilities or locations where only one or just a few licensed veterinarians have been authorized to do business, have struggled to profitably and effectively manage and dispense veterinary pharmaceuticals and animal supplements. This has been in part due to the lack of a system for effectively integrating work flow of animal pharmacies and animal care providers such as veterinarians and veterinary hospitals.

FIG. 1a illustrates a traditional method of applying taxes and regulatory fees to the sale of veterinary pharmaceuticals and other animal related products by a hospital pharmacy 109, such as at a traditional veterinary hospital or other animal treatment facility where a licensed veterinarian is authorized to do business. Because there are such a large number of veterinary products that are constantly changing, it is difficult at best for an animal hospital to stay current and remain profitable while managing the large number of products necessary for different animal treatment conditions encountered. Maintaining inventory against becoming stale or otherwise outdated has been a challenge in such a situation.

Further, from a product pricing perspective, it has been challenging for individual hospital pharmacies 109 to maintain profitability while costs, including taxes and other regulatory fees, on a wide array of products have frequently varied and changed from time to time.

Referring to FIG. 1b, for these and other reasons there have developed centralized veterinary pharmacies 105 which have offered the advantage of having been better able than a smaller hospital pharmacy 109 to stay current and keep fresh stock. But these centralized pharmacies 105 have not adequately integrated the hospital or veterinarian in the loop of treatment of animals or profitability regarding the sale of veterinary products. Accordingly, there has been a disincentive in the more traditional centralized veterinary pharmacy system for animal hospitals to send customers to such centralized pharmacies, since animal hospitals have not been included in the profitability loop and have also reported concerns of losing customers and not being adequately involved in treatment of animals, since such centralized pharmacies have had more exclusive and direct contact with pet owners. Though some of this problem has been alleviated by legally requiring veterinarians to more frequently see the animals for which prescriptions are made, this doesn't address the lack of profit incentive for veterinarians to deal with traditional centralized pharmacies associated with prior art pricing systems. Ultimately, it has been understood that cutting veterinarians out of the animal treatment and profitability loops in animal care has been unwise and has not been good for the animals, their owners, veterinary hospitals or individual veterinarians.

Since there is currently a very large number of supplement and pharmaceutical treatment options available for animals presenting a wide variety of disorders and conditions, it has been very difficult, if not impossible, for a veterinarian, or a small veterinary hospital, to have maintained in stock sufficient quantities of each of the many and varied medications available, without such supplies becoming stale, losing potency, or expiring. Further, the management of such inventory, even if possible, would be very cumbersome, labor intensive, and expensive. Since there is such a wide variety of pharmaceutical, over-the-counter and supplement treatment options for animals today, it has been very difficult for an in-hospital pharmacy to stay current on and keep all of the many products available in fresh supply. This problem has been exacerbated by the fact that, with some medications or products the number of animals for which the product may have been beneficially prescribed has been relatively small.

In short, traditional methods of pricing, accounting for and distributing taxes and regulatory fees from animal product sale proceeds have exhibited many shortfalls. Since the prior art method of pricing, application of taxes and regulatory fees, and proceeds allocation and distribution has not been dynamic or automated, there has been increased cost to the end-user because the pharmacy has had to increase the price of the product to protect against unforeseen interim cost changes. This is especially true where a large number of products must be overseen. Or alternatively, prior art increase changes in wholesale pricing would have negatively impacted profitability for the pharmacy.

Static retail pricing of veterinary pharmaceuticals and other animal products that does not readily account for variability in taxes and other regulatory fees puts everyone in the veterinary product sale and delivery transaction at risk of loss from a tax or fee change up or down as shown at A, B and C of FIGS. 1a and 1b. As shown at lines A, B and C, regulatory entities modify taxes and fees, usually in the upward direction, as shown at 102, 103, 104, and these changes are not readily accommodated by changes in product pricing as shown by 110, 111, 112. In the case of line C of FIG. 1a, in part because of a tax or regulatory fee increase, the tax cost to the hospital is greater than the tax collected 112, and the hospital 109 is thus incurring a tax liability on each sale of the product that may or may not be known to the hospital. Similarly, in the case of FIG. 1b, in part because of a tax or regulatory fee increase, the central product provider's 105 tax cost increases as shown at 102, 103, 104 without a corresponding price increase at 110, 111, 112 causing the central product provider to incur a tax liability, and hence lose money, on each sale of the product. Again, to mitigate the losses associated with variability of tax and regulatory fee changes, the retail prices paid by customers may tend to be higher than they need to be to make sure that distributors and retailers have sufficient margin to cover for errors and omissions regarding costs in the supply chain.

Veterinarians and veterinary hospitals have heretofore not had the time, technology, methods or processes to effectively participate in animal product sale transactions, since the means of tracking the myriad of products and their price and associated tax and fee changes has proven daunting to say the least. To date, there hasn't been an effective, comprehensive, integrated and computerized system in place that would have been highly beneficial to pet owners and animals and that would have incentivized animal hospitals with profitability on pharmaceutical and other product sales. This has been due, in some part, to the fact that very large product development costs have not previously been able to have been spread over a larger number of customers, such that these large development costs have been prohibitive to making new products. However, now that economies of scale have been introduced into the system with addition of the concept of centralized pharmacies selling products to a much wider range of customers, and with the advent of computer database technology, a novel system and method of integrating animal hospitals, pharmacies and customers around product sales has been needed. Without such an integrated system, the products would have been too expensive to develop.

Since an effective product sales channel and associated system and method in which veterinary hospitals could participate profitably has been lacking, this has, in the end, naturally resulted in a more limited range of treatment options for animals. More particularly, the inability of prior art centralized pharmacies to more effectively control costs by putting tighter tolerances and granularity on price change strategies with a computer controlled, dynamic price modification system, in order to better facilitate integration of animal clinics into the product sales transaction loop, whether it be in a consumer direct or a hospital sale, has been an impediment to profitable participation by veterinarians in this aspect of animal treatment. And this, in turn, has led to less involvement of the veterinarian in treatment of animals, when ideally the veterinarian should be more involved rather than less.

Lesser involvement of veterinarians in treatment plans has been shown to negatively impact compliance by animal owners and others in administering recommended treatments to animals. Largely, such noncompliance has resulted from inherent delay and the inconvenience placed upon the owner to return to the veterinarian to renew prescriptions, to hand-carry prescriptions to the local pharmacy, wait to have them filled, and to remember to administer the treatment as prescribed to the animal according to the treatment plan. Thus, non-compliance may include any deviation from the treatment plan of the veterinarian, such as an owner's failure to renew the prescription, failure to refill the prescription and do so in a timely manner, or failure to administer the treatment and do so in a timely manner according to the treatment plan. Since the animal has been mostly unable to indicate need for treatment, compliance has been left primarily to the owner in this traditional scenario, and diminished compliance has resulted.

It is distressing that there has been a very low compliance rate in the administration of pharmaceuticals to animals, documented as between 34-48 percent among customers of veterinary preventative medications, and 19% for therapeutic diets, as published in the 2003 AAHA study, The Path to High-Quality Care: Practical Tips for Improving Compliance.

And this scenario of complication of appropriately computing accurate retail pricing, complication of determining regulatory compliance with taxing and other agencies and subsequent proceeds allocation and distribution to animal hospitals, centralized veterinary pharmacies and regulatory authorities has been exacerbated by the need for treatments that have involved the administration of multiple doses of medicine or supplement on a periodic basis, for example weekly, to the animal caretaker. As medicines and products have become more advanced, there has been an advantage associated with periodic dosing, and this has only complicated the financial aspects of animal product sales transactions, requiring computerized facilitation of such transactions.

Accordingly, there has been a need for a computer-enabled, automated dynamic tax and regulatory fee application, determination and distribution system for use with a centralized pharmacy for service to multiple, distributed animal treatment facilities and veterinarians. There has been a need for a system that is cooperative in nature, a system that supports a veterinary product distribution channel in which every participant involved has a high level of confidence in the system and every participant is incentivized to participate in the system.

Further, there has existed a need for removal of complicated and burdensome regulatory compliance from veterinarians and veterinary hospitals, while at the same time allowing for funding of regulatory agencies to provide consumer and animal protection roles. Prior art methods have effectively cut animal hospitals and veterinarians out of the loop because they have not had the profit incentive or the staff support to effectively comply with such regulatory and compliance requirements. And this, in turn, has negatively impacted the competitiveness of veterinary hospitals and served to limit the number of treatment options available to animal caretakers.

Likewise, the aforementioned impediments have led to a disincentive for research and development for increasingly better animal pharmaceuticals and products.

From an animal pharmacy's perspective, it has been difficult to integrate many disparate providers of animal care services with a standard product offering that is effectively managed, given the many different products available and the fact that the product list and pricing is constantly changing. Such difficulty has further acted to prevent involvement of individual veterinarians and animal hospitals in transactions involving the sale of veterinary pharmaceuticals and other animal-related products, since pharmacies have had only less effective means of marketing to and creating relationships with animal care providers. For example, prior methods of marketing animal pharmaceutical products to veterinarians have involved a system of advance sheets and traditional marketing literature provided to veterinarians and hospitals by drug sales representatives who have, on behalf of drug manufacturers, called on the veterinarians and hospitals.

Accordingly, it has been a challenge for veterinary hospitals and veterinarians to participate successfully in, and profit from the sale of, pharmaceutical and other animal-related products for treatment of animals seen at the veterinary hospital. And this, in turn, has negatively impacted the treatment of animals, since already low rates of compliance with veterinary treatment regimens overall are worsened where the veterinarian is not effectively involved, financially or otherwise, in the pharmaceutical and supplement dispensing and supplying process. This situation is complicated in the case of treatments that have involved the administration of multiple doses of medicine or supplement on a periodic basis, for example weekly, or daily for a period of time.

Prior non-computerized methods and systems of enabling, controlling and managing the processing, fulfilling, dispensing and handling of sales of animal-related products have not included automated means of applying, determining, accounting and distributing of tax and other regulatory fee proceeds to enable veterinarians and animal hospitals to effectively participate and profit from the sale directly to customers of the increasingly larger varieties of products available. As such, traditional prior art methods and systems of dispensing veterinary pharmaceuticals have not employed effective means for veterinarians and their staff to participate in the product sale transaction and thus more positively impact compliance of the animal owner in using the prescribed medication or supplement to support more effective treatment outcomes. Thus, in addition to the need for an effective and automated method of applying, determining, accounting and distributing of tax and regulatory fee proceeds from the sale of animal-related products, there has been needed an effective and automated method to include animal hospitals and veterinarians in the allocation and distribution of proceeds from sales of such products.

Prior attempts to address the basic limitations of manual ordering, fulfillment and dispensing of animal product systems, as with a typically customer-centric, centralized pharmacy accessible by the customer, or alternatively by the veterinarian, by telephone or the Internet, have not adequately involved the animal hospital, or veterinarian, in the process, either from a dispensing follow-up standpoint or from a financial standpoint. Thus, while such systems have enabled improvements, allowing greater ease for the animal owner to access the pharmacy via telephone or Internet, and hence they have somewhat increased the efficiency of fulfilling prescriptions, these systems have not effectively incentivized participation of the animal hospital and thus have limited the otherwise beneficial participation by the animal hospital in the transaction. And this ultimately has negatively impacted compliance with animal treatment plans.

Further, though with previously described methods and systems, sometimes a veterinarian has been able to call in, fax in, or email in a prescription directly to the central pharmacy for manual pickup by the customer, such solutions have lacked a coherent strategy and computerized system for automated pricing and selection by the animal care provider while automatically accounting for and distributing sales taxes and other regulatory fees to the veterinary hospital collected in association with such sales. Such a system is needed that is customizable by and for each animal care provider and that is easy to operate and determine retail prices while ultimately enabling the animal care provider to benefit from its efforts and be involved in this aspect of the ongoing treatment of the animal.

Prior art telephone or Internet enabled systems have not been well designed to account for the fact that, in order for a veterinarian to issue a prescription, he or she must first see the animal for which the treatment plan is issued. Therefore, while the telephone or Internet enabled model of distributing veterinary pharmaceuticals has somewhat facilitated the distribution of medicines, it still has lacked a viable method for involvement of the veterinary hospital in the offering and selection of products and ultimately the creation of more effective animal treatment plans by a veterinarian that is intimately familiar with the animal. Of course, with such prior art systems a veterinarian could call or fax a remote central pharmacy and place a medication order, based on a relatively incomplete system of advance sheets received by the hospital from drug manufacturers, and that order could be shipped to the customer directly by the central pharmacy, but this method has required additional steps for the veterinarian to send the prescription to a remote pharmacy and has lacked a comprehensive system for facilitating customizable product sales by the hospital and individual prescribing veterinarians together with the application, determination and distribution of taxes and other regulatory fees associated with the sale of the animal-related products. Such a system has been needed while managing and facilitating the process and relationship between the hospital and the pharmacy, all while fostering an economic incentive for the veterinarian and hospital to use a particular pharmacy.

In fact, such prior art systems may have introduced a disincentive for better hospital and pharmacy relationships, because once the customer has been introduced to the pharmacy with such prior art, centralized telephone and Internet pharmacy methods, the pharmacy may have developed, and frequently has developed, a direct relationship with the animal owner, selling additional products and services directly to the owner with no supervision and no economic benefit to the veterinarian. Thus, such systems have done little to improve the compliance of administering pharmaceuticals and supplements in accordance with a veterinarian-prescribed treatment plan, since in such case follow through with treatment has still been left almost exclusively to the animal owner.

While the foregoing clearinghouse-type centralized pharmacy solutions have sought to address the inability of veterinarians to effectively and profitably participate in long term treatment plans of animals, as described above, the solutions have entailed other problems, have not provided a comprehensive, yet customizable, means of presenting products for selection by a veterinarian, have not provided automated, dynamic pricing of products for veterinarians, have not provided automated application, determination and distribution of taxes and other regulatory fees for veterinary hospitals and veterinarians, have not addressed compliance issues as described, and have not adequately involved the veterinarian in the process or transaction, financially or otherwise, sufficient to ensure the high-quality treatment that owners expect for their pets and other animals.

### SUMMARY OF THE INVENTION

In accordance with a first aspect of the invention, there is provided a computer-enabled method for dynamic, automated application of taxes to veterinary pharmaceutical and other animal-related product items for sale by a central product provider. The method allows subsequent recovery of historical information regarding details of tax applied to the sale of the animal-related products by the central product provider for subsequent use to credit and distribute taxes collected from sale of the product to taxing authorities. The method comprises the following steps: (a) in a central product provider computer, asynchronously creating and storing in a computer readable medium member account details for a customer identified by a unique customer ID that is associated with a customer profile comprising customer location information and any associated veterinary hospital identified by a unique hospital ID; (b) in the central product provider computer, retrieving in a computer-readable medium at least one per-item tax record, each per-item tax record comprising at least a unique per-item tax ID field, a product ID field, a location code field, a tax amount field and a tax rate field; (c) responsive to a request from a customer computer, in a central product provider computer, creating in computer readable memory a temporary invoice record comprising a unique invoice ID, temporarily storing in the invoice record any veterinary hospital ID, the customer ID of the customer making the request, a location code, and providing to the customer computer item product information for at least one item for selection; (d) responsive to a selection from the customer computer, in the central product provider computer, retrieving at least one per-item tax from computer readable medium and temporarily storing in the invoice record a snapshot for subsequent optional recall of product item record information comprising at least: (i) a unique product ID, (ii) the current base price corresponding to the selected item, (iii) at least one per-item tax corresponding to the selected item, the at least one per-item tax comprising a tax ID and a per-item tax amount comprising the sum of at least the following: (a) any per-item tax value obtained from the per-item tax amount field referenced by the location code and the product ID; (b) any per-item tax value obtained by multiplying any associated per-item tax rate from the per-item tax rate field referenced by the location code and the product ID; (iv) an item price total comprising the sum of at least the item current base price and the at least one per-item tax amount; and (e) making available for display at the customer computer the selected item information and the corresponding total selected item price.

In accordance with this aspect of the invention, the at least one per-item tax comprises at least one of the following federal, state, county, city, and other local animal product sales taxes: nutrition, equipment, prescription, pharmaceutical, non-prescription and over-the-counter. Further the per-item taxes may be determined by product ID and location code in accordance with an individual product, a category of products or a subcategory of products. The product ID may therefore comprise a composite identification number comprising a portion that is dedicated or refers to a category of products identified by tax tables, a portion that refers to one or more subcategories, or types, of products identified by the tax tables, and a portion referencing a specific product in the tax tables. It will be appreciated by those of ordinary skill in the art that other taxes and required fees may be included as per-item taxes without departing from the true scope and spirit of the invention. In this sense, the term tax is used in a generic and broad form to include any required or mandated tax or fee to be paid to a third party such as a taxing or regulatory authority.

Further, in accordance with this aspect of the invention, the steps of the method are preferably repeated for each item product selected for inclusion on the invoice or order, the method creating an item record temporarily stored in the temporary invoice record for each iteration of the steps of the method. In this way, each item of the order includes any separate per-item tax.

In accordance with another aspect, the invention further comprises the following steps: (a) in the central product provider computer, retrieving in a computer-readable medium at least one per-invoice tax record, each per-invoice tax record comprising at least a per-invoice tax ID field, a location code field, a per-invoice tax amount field and a per-invoice tax rate field; (b) in the central product provider computer, responsive to a confirmation of an intention to purchase the at least one item temporarily stored in the temporary invoice record, retrieving and storing in the invoice record at least one per-invoice tax comprising an associated tax ID and an associated tax amount comprising the sum of at least the following: (i) any per-invoice value obtained from the per-invoice tax amount field referenced by the location code; (ii) any per-invoice value obtained by multiplying any associated tax rate from the per-invoice tax rate field referenced by the location code; (c) calculating and storing in the invoice record an invoice total comprising each product item price total and the at least one per-invoice tax; and (d) marking the invoice record as open and transferring the invoice record to an invoices database.

In accordance with this aspect of the invention, and wherein the unique customer ID references a wallet database with at least one set of credit card processing information for the customer, the following additional steps are performed: (a) processing payment of the invoice total using the at least one set of credit card processing information; (b) obtaining approval from the credit card financial institution; and (c) marking the invoice as paid.

The at least one per-invoice tax in accordance with this aspect of the invention comprises at least one of the following taxes: federal, state, county, city, and other local animal product sales taxes. It will be appreciated by those of ordinary skill in the art that other required taxes and fees may be included as per-invoice taxes without departing from the true scope and spirit of the invention, and the term taxes in this context includes any required tax or fee payable to a third party such as a government entity or other regulatory body. While a preferred embodiment of the invention comprises primarily state, county, city and local animal product sales taxes, it will be appreciated that federal and other municipal taxes may be employed.

These first two aspects of the invention address the limitations of the aforementioned prior art manual pharmaceutical and animal product tax application and distribution systems, as well as the limitations of tax systems used by telephone or Internet-based centralized animal pharmacies. Of course, since a centralized pharmacy is more able to be effectively employed with the invention, the issues of large numbers of products, and specialty products which are not used by a very large number of animals, are greatly minimized. With the present invention, a larger centralized pharmacy is enabled to effectively apply, determine and distribute the many per-item and per-invoice taxes to veterinary hospitals for taxing authorities and other regulatory bodies and associated with the sale of a diversity of animal pharmaceuticals and products.

Each individual regulatory body's taxing or regulatory fee information is able to be accessed at a third party tax tables service on a per sale basis, or alternatively as a batch or other process at the central product provider computer, or other networked computer or peripheral device asynchronously stored and updated on the central pharmacy's server system. Tax and regulatory fee changes are captured in snapshot fashion for later use with each invoice record as the invoice is made. Accordingly, an historically accurate record of taxes as they are and were applied is created such that, interim changes to the taxes, whether they be per-product-item or per-invoice tax changes, take place immediately and immediately reflect associated product price changes before presentation to the customer. Further, the information is also available for recall by the central product provider to automatically record, credit and distribute funds to each veterinarian, or veterinary hospital, for subsequent payment to the appropriate taxing authority. And since the customer is enabled to purchase products directly from a website for the animal hospital maintained by the central product provider, or alternatively at a point of sale terminal at a hospital computer linked to the central product provider computer, this in turn adds to the ability of veterinary hospitals to more effectively participate in the sale of veterinary products to their customers since the burdensome regulatory aspect of collecting and accounting for taxes is now able to be performed by a central product provider.

Further, since the veterinary hospital is able to participate effectively in the transaction, it is incentivized to build and maintain a good relationship with the centralized product provider/pharmacy. This is not only good for business for each party involved, but this also results in more effective service to animal-owner customers, other animal caretakers and their animals.

The steps of the method of these latter aspects of the invention make available to customers of a particular hospital an e-commerce website for enabling veterinary hospital customers to select and purchase products previously made available by their hospital. This, in turn, enables users to access the hospital's product offering via the hospital's website. In this way, the value added service provided by the hospital to its customers helps solidify the relationship between the hospital and its customer.

Since the system of the invention allows centralized processing and payment of tax and other regulatory fees associated with animal product sales at point of sale terminals at hospitals or at a myriad of customer locations via the Internet, the centralized product provider is enabled to make product offerings of automatically and dynamically priced products for sale to customers for a large number of smaller, in many cases, and disparate veterinary treatment centers—effectively enabling them to participate in the sale of animal-related pharmaceuticals and products directly to their customers. This, in turn, positively impacts compliance with veterinary treatment programs.

In accordance with yet another aspect of the invention, the method further comprises automated determining, allocating, crediting and distribution of at least one tax invoiced and paid at sale of an animal product, wherein the at least one tax comprises a tax ID associated with a tax amount stored in an invoice record. After sale of a product and collection of monies associated with the sale, this aspect of the invention, further comprises the steps of: (a) retrieving into a computer-readable medium at least part of a marked paid invoice record from an invoices database and containing a unique invoice ID, a unique customer ID and at least one tax ID and associated tax amount; (b) for each tax ID from the invoice record, using the tax ID to retrieve tax authority information; (c) recording each collected tax amount in a veterinary hospital's ledger; (d) distributing collected tax amounts to the veterinary hospital's account; and (e) marking the invoice as closed.

This aspect of the invention provides for determination, allocation, crediting and distribution of collected taxes to the appropriate veterinary hospital based upon updated per-item and per-invoice tax change tracking, whether the sale of veterinary products is to the hospital itself for use on its own account, to a hospital customer who purchases at a point of sale hospital computer terminal, or to a hospital, or veterinarian, customer who purchases at an e-commerce website hosted for the hospital by the central product provider.

In accordance with this aspect of the invention, the burden of tracking constantly changing taxes and regulatory fees, as well as accounting for taxes collected, is effectively removed from the backs of veterinarians and veterinary hospitals with the system of the invention and related reporting capability.

Since the system of the invention allows appropriately priced products to be sold over the Internet, either with an E-commerce application usable by the pet owner at his or her home, or at a point-of-sale terminal at the animal hospital, with convenient delivery of the ordered product to the customer's doorstep, the invention effectively accommodates a large number of smaller, in some cases, and disparate veterinary treatment centers—effectively enabling them to participate in the sale of animal-related products directly to their customers—thus positively impacting compliance with veterinary treatment programs.

With regard to direct purchases of products by customers over the Internet, this aspect of the invention may be viewed as primarily for products not requiring a prescription authorization from the veterinarian hospital, such as supplements, feeds, over-the-counter treatment regimens and the like. However, this feature may also enable a user to purchase re-fills of already authorized pharmaceuticals. For example, a veterinarian may authorize a heartworm medication for an animal that may be renewable for six months. If the customer didn't want to purchase all six months in advance, he or she could access the hospital's website through a secure account to purchase pre-authorized refill medications for which the animal has already been seen by the veterinarian, and the appropriate taxes and regulatory fees associated with the purchase of the product at that time would be applied to the sale and distributed to the appropriate authority.

Similarly, where a customer commits to purchase an animal product for a period of time, for example monthly for 12 months, and they want to pay monthly for the 12-month period, the system will automatically refill the order each month and charge the customer's credit card. The current sales/product tax rate will be applied to each monthly transaction and will be automatically credited and distributed to the appropriate hospital or veterinarian for payment to the appropriate taxing authorities in accordance with a report able to be provided to the hospital or veterinarian by the central product provider. Thus, the system of the invention accommodates tax administration for recurrent purchases of products, whether they be pharmaceutical, non-pharmaceutical, nutrition, equipment or other animal products.

Since, as shown in FIG. 1c, in accordance with the present invention the veterinarian is conveniently placed at the center of the supply of pharmaceuticals and other products in the processes of the invention, the veterinarian is supported in providing better care to the animal and in enabling better compliance by the animal owner with treatment plans. This coherent, comprehensive, veterinarian-centric method and system of supplying animal-related products to animal owners for administering treatments to their animals fosters appropriate and best practices for practicing veterinarian medicine.

Further, as shown in FIG. 1c, the veterinary hospital avoids the erosion of its profit margin, since the invention enables immediate, real-time, pricing increases associated with tax and regulatory fee increases as shown in rows A, B and C. Conversely, the invention enables the veterinary hospital to avoid overcharging customers where tax and regulatory fees are decreased.

As an overall summary of the various aspects of the invention, there is provided a computer-enabled method for dynamic, automated application of taxes to veterinary pharmaceutical and other animal-related product items for sale by a central product provider. There is also provided subsequent recovery of historical tax application information by the central product provider for automated tax determination, crediting and distribution to a veterinary hospital of at least one tax invoiced and paid from a customer wallet database at the sale of the animal-related product Thus, together with the forgoing, all of the aspects of the invention combined comprise the following steps: (a) in a central product provider computer, asynchronously creating and storing in a computer readable medium member account details for a customer identified by a unique customer ID that is associated with a customer profile comprising customer location information and any associated veterinary hospital identified by a unique hospital ID; (b) in the central product provider computer, retrieving in a computer-readable medium at least one per-item tax record, each per-item tax record comprising at least a unique per-item tax ID field, a product ID field, a location code field, a tax amount field and a tax rate field; (c) in the central product provider computer, retrieving in a computer-readable medium at least one per-invoice tax record, each per-invoice tax record comprising at least a per-invoice tax ID field, a location code field, a per-invoice tax amount field and a per-invoice tax rate field; (d) responsive to a request from a customer computer, in a central product provider computer, creating in computer readable memory a temporary invoice record comprising a unique invoice ID, temporarily storing in the invoice record any veterinary hospital ID, the customer ID of the customer making the request, a location code, and providing to the customer computer item product information for at least one item for selection; (e) responsive to a selection from the customer computer, in the central product provider computer, retrieving at least one per-item tax from computer readable medium and temporarily storing in the invoice record a snapshot for subsequent optional recall of product item record information comprising at least: (i) a unique product ID, (ii) the current base price corresponding to the selected item, (iii) at least one per-item tax corresponding to the selected item, the at least one per-item tax comprising a tax ID and a per-item tax amount comprising the sum of at least the following: (a) any per-item tax value obtained from the per-item tax amount field referenced by the location code and the product ID; (b) any per-item tax value obtained by multiplying any associated per-item tax rate from the per-item tax rate field referenced by the location code and the product ID; (iv) an item price total comprising the sum of at least the item current base price and the at least one per-item tax amount; (f) making available for display at the customer computer the selected item information and the corresponding total selected item price; (g) in the central product provider computer, responsive to a confirmation of an intention to purchase the at least one item temporarily stored in the temporary invoice record, retrieving and storing in the invoice record at least one per-invoice tax comprising an associated tax ID and an associated tax amount comprising the sum of at least the following: (i) any per-invoice value obtained from the per-invoice tax amount field referenced by the location code; (ii) any per-invoice value obtained by multiplying any associated tax rate from the per-invoice tax rate field referenced by the location code; (h) calculating and storing in the invoice record an invoice total comprising each product item price total and the at least one per-invoice tax; (i) marking the invoice record as open and transferring the invoice record to an invoices database; (j) retrieving the invoice marked as open into computer readable memory, using the unique customer ID to reference a customer wallet database with at least one set of credit card processing information for the customer, processing payment of the invoice total using the at least one set of credit card processing information, obtaining approval from the credit card financial institution, marking the invoice as paid; (k) retrieving into a computer-readable medium at least part of a marked paid invoice record from an invoices database and containing a unique invoice ID, a unique customer ID and at least one tax ID and associated tax amount; (l) for each tax ID from the invoice record, using the tax ID to retrieve tax authority information; (m) recording each collected tax amount in a veterinary hospital's, or veterinarian's, ledger; (n) distributing collected tax amounts to the veterinary hospital's account; and (o) marking the invoice as closed.

It will be appreciated that the central product provider computer, as well as any of the vendor computers, may readily comprise a plurality of computers networked via at least one of local network, Internet, wireless network and satellite network that jointly perform the same functions as a single computer, without departing from the true scope and spirit of the invention.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters on the accompanying figures refer to like elements.

### BRIEF DESCRIPTION OF THE DRAWINGS

FIG. 1a is a schematic representation demonstrating changes in taxes and regulatory fees in a static pricing model for sale of veterinary pharmaceuticals and other animal products wherein a veterinary hospital is functioning as an animal pharmacy fulfilling prescriptions directly to a customer in accordance with prior art;

FIG. 1b is a schematic representation demonstrating changes in taxes and regulatory fees in a static pricing model for sale of veterinary pharmaceuticals and other animal products wherein a central product provider pharmacy is fulfilling prescriptions directly to a customer in accordance with prior art;

FIG. 1c is a schematic representation demonstrating changes in taxes and regulatory fees in a dynamic pricing model for sale of veterinary pharmaceuticals and other products in a channel wherein the veterinary hospital is interposed between the central pharmacy and the customer in accordance with the present invention;

FIG. 2 is a schematic representation illustrating an overall system comprising client computers, servers and databases for application of taxes and regulatory fees to animal-related products and sale proceeds and subsequent distribution of the taxes and fees to corresponding regulatory entities;

FIG. 3a is a schematic diagram of part of a system in accordance with the present invention for asynchronously updating in a computer readable medium at a central product provider computer details, including hospital, customer and wallet information, for veterinary hospital and customer members of the central product provider system;

FIG. 3b is a schematic diagram of part of a system in accordance with the present invention for manual updating of a central product provider computer with a plurality of product item records and per-product and per-invoice tax and regulatory amounts and rate records;

FIG. 3c is a schematic diagram of a part of a system in accordance with the present invention where the central product provider computer obtains per-product and per-invoice taxes and regulatory fees from tax tables, whether maintained by a third party tax table providing service or directly from taxing authorities;

FIG. 4a is a schematic process flow diagram illustrating the process for aggregation of per-product item taxes and regulatory fees associated with the sale of each animal product in accordance with part of the present invention;

FIG. 4b is a schematic process flow diagram illustrating subprocess details of retrieving the base price of a product item for sale in accordance with a part of the invention;

FIG. 4c is a schematic process flow diagram illustrating subprocess details of aggregating of per-item taxes and regulatory fees associated with a particular product for sale and in accordance with a part of the invention;

FIG. 4d is a schematic process flow diagram illustrating the process for tax table lookup either a remote service provider or a local tax table database;

FIG. 5a is a schematic process flow diagram illustrating the aggregation of per-invoice taxes and regulatory fees associated with each invoice in accordance with a part of the present invention;

FIG. 5b is a schematic process flow diagram illustrating subprocess details for aggregation of per-invoice taxes and regulatory fees associated with each invoice in accordance with a part of the present invention;

FIG. 6 is a schematic process flow diagram illustrating the processing of payment for purchase of animal products in accordance with a part of the present invention;

FIG. 7 is a schematic process flow diagram illustrating the allocation, distribution and accounting of product sale tax and regulatory fee proceeds to tax authorities and regulatory agencies in accordance with a part of the present invention;

FIG. 8 is an entity relationship diagram illustrating preferred organization of data structures of computer readable medium of a central product provider computer for a master products database, a categories database, tax tables, hospital membership profiles, customer membership profiles and credit card wallets in accordance with a part of the present invention;

FIG. 9 is an entity relationship diagram illustrating preferred organization of data structures of computer readable medium for invoices introduced into the central product provider computer, each invoice having one or more items and any associated per-item and per-invoice taxes and regulatory fees in accordance with part of the present invention;

FIG. 10 is a table showing invoice status and the meaning of each status option;

FIG. 11 is a schematic diagram illustrating preferred organization of a data structure of computer readable medium for an invoice record in accordance with part of the present invention;

FIG. 12 is a schematic diagram illustrating preferred organization of a data structure of computer readable medium for a per-item tax and regulatory fee record in accordance with part of the present invention;

FIG. 13 is a schematic diagram illustrating preferred organization of a data structure of computer readable medium for a per-invoice tax and regulatory fee record in accordance with part of the present invention;

FIG. 14 is a schematic diagram illustrating a preferred organization of product ID layout comprising category, subcategory and stock keeping unit (SKU).

### DETAILED DESCRIPTION

### System Overview

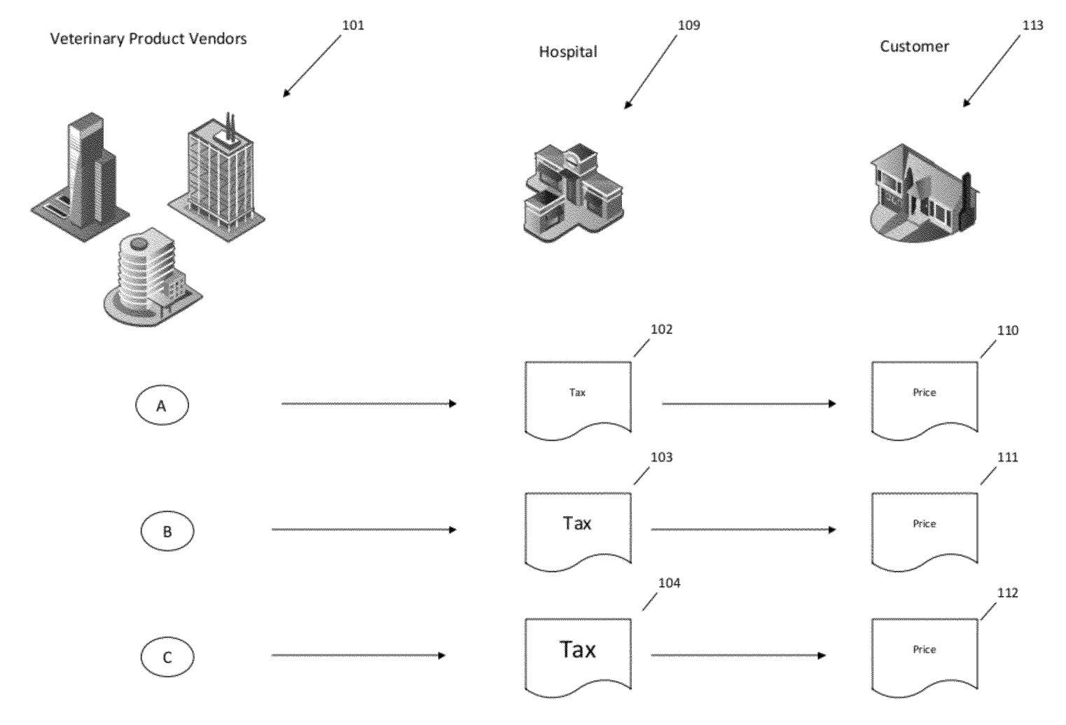

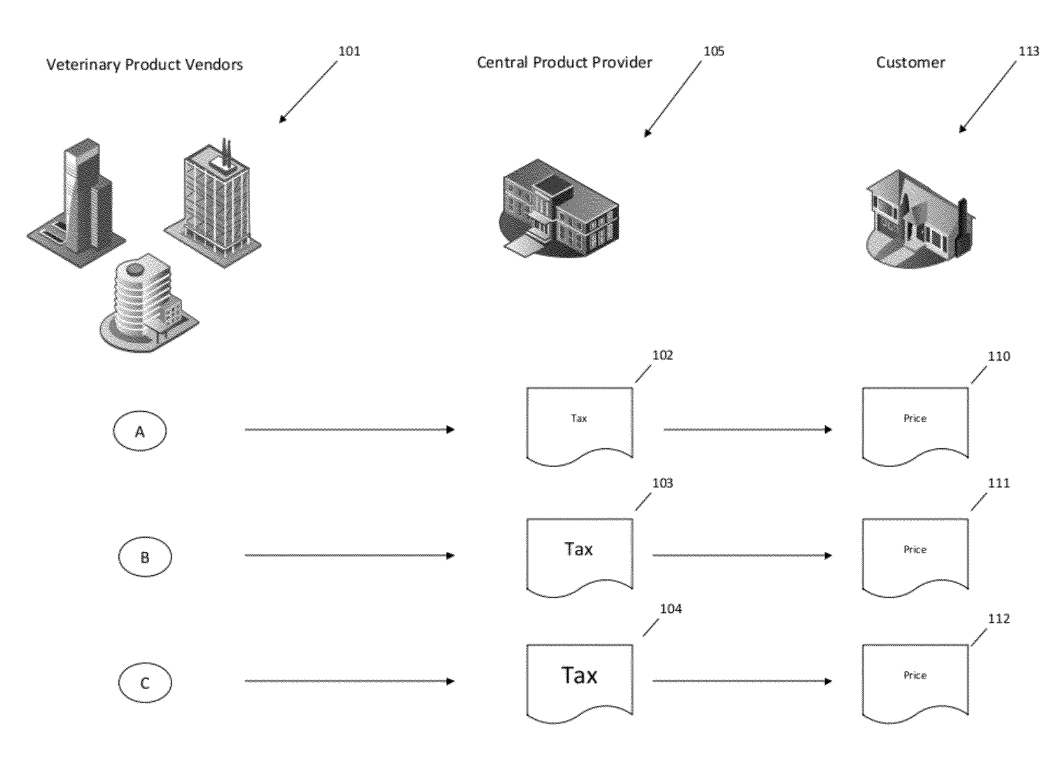

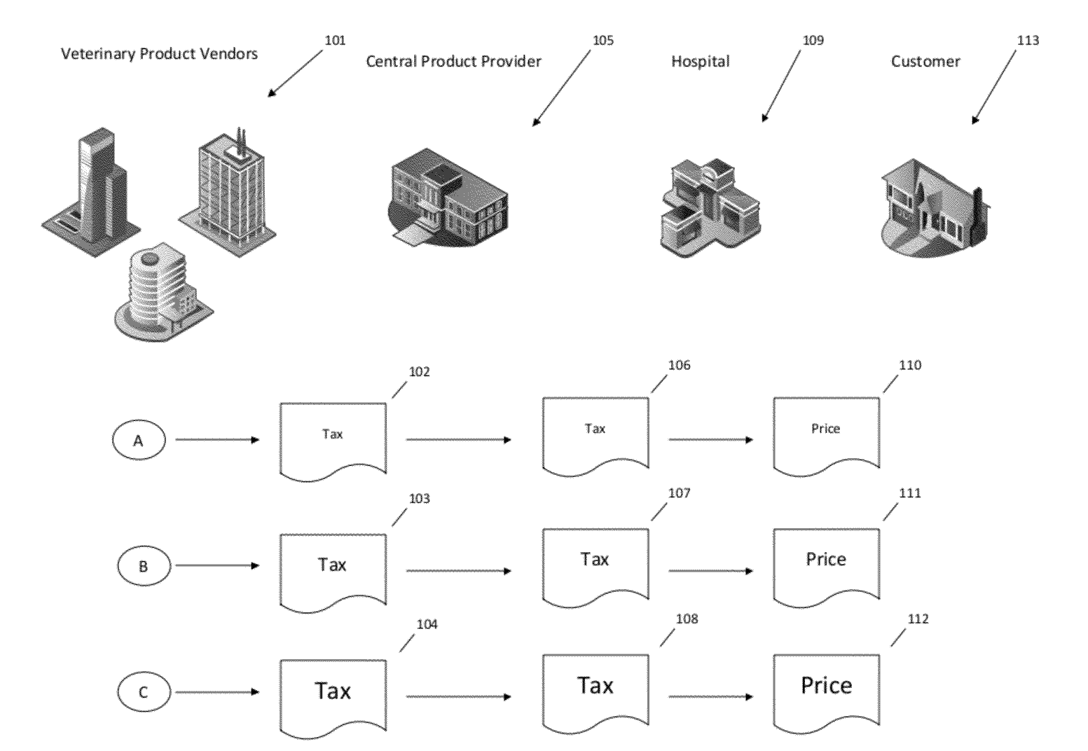

Referring to FIG. 1c, there is illustrated a channel for distribution of animal-related products from manufacturer 101, through central product provider 105, through a veterinary hospital 109, and ultimately to a customer 113. Thus, the veterinary hospital 109, in accordance with the present invention, is interposed between the central product provider 105 and the customer 113. This interposition is not strictly required for all transactions, but rather suggests importantly the sharing of proceeds and distribution of collected taxes and regulatory fees with the veterinary hospital 109 in such a way that the veterinary hospital is able to participate in the transaction, profit therefrom and be enabled and assisted by the central product provider 105 in remitting taxes to taxing authorities.

An important benefit of the type of channel illustrated by FIG. 1c is that prices to the customers 113 are more accurate in real time. In other words, the customer doesn't pay an artificially higher price (or not, resulting in loss to the veterinarian) to account for inability to efficiently pass along fluctuations in taxes, regulatory fees and other cost factors in the distribution chain. Thus, as illustrated, in row A, the tax is consistent from point 102 to 106 and the price at 110 is correspondingly small. As illustrated in row B, the increase in tax at 103 is consistently reflected in a larger tax at 107 and correspondingly higher price at 111. The same holds true for row C, where a still higher tax at 104 is appropriately reflected in the tax 108 and price 112. It will be appreciate by those of ordinary skill in the art that the reverse is also true, wherein a decrease in tax cost would be immediately reflected in a price decrease for the customer as well.

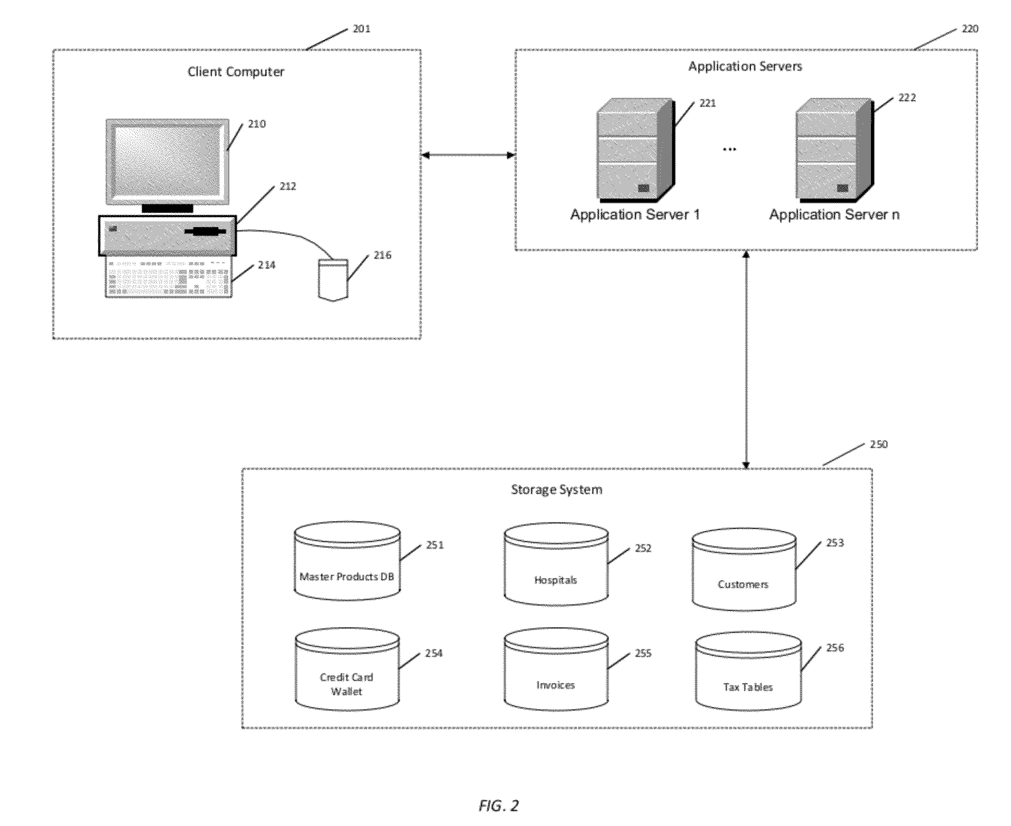

Referring to FIG. 2, client computer system 201 is one of a plurality of such client computer systems being located at a veterinarian hospital, including any animal treatment facility or location where a licensed veterinarian is authorized to do business, and the application server systems 220 with supporting data storage system 250 may support many such hospitals having such plurality of client computer systems 201. As is important to an alternative embodiment of the invention, client computer system 201 may be, alternatively, a client computer system in an animal hospital customer's home.

While each client computer system 201 preferably comprises a traditional monitor 210, processing hardware 212, keyboard 214, mouse 216, application software, Internet software and hardware components (not shown), it will be appreciated by those of ordinary skill in the art that any computer system, such as a smart phone, hand-held device, laptop, or other equivalent computing device with adequate memory and processing capability will satisfy the client computer system for purposes of the present invention. Further, multiple client computer systems 201 may be networked, for example on an Ethernet-type network within a hospital complex, the networked systems being represented in whole by client computer system 201 as is well understood by those of ordinary skill in the art. Further, it will be appreciated by those of ordinary skill in the art that the invention may be used to support many individual veterinarians and hospitals, including veterinary practices of various different sizes and geographic locations, by considering veterinarians and hospitals to be one and the same, as members, in the database.

Client computer systems 201 may run any type of client computing operating system and software, such as Windows®, Mac OS®, Linux®, Android® or others, that enables access by the user of the client computer system to the Internet and the ability to process application data within the client portion of the application software of the invention on the client computer system.

One or more application servers 220, comprising parallel processing, mirrored, or RAID configured servers 221, 222, etc., run the server side portion of the application software of the invention and provide secure access to data in the storage system 250. Servers 220 may comprise a plurality of servers that are housed in a single location where the size of the system permits and there exists sufficient power and security to meet reliability and availability needs. The servers 220 are preferably interconnected to each other and to data storage system 250 by a high-speed local networking system. Servers 220 are also connected to the plurality of client computers 201 via the Internet or other network system.

Storage system 250 preferably comprises a redundant array of magnetic storage media disk drives, optical storage system, or the like, capable of the fast access and retrieval times necessary to accommodate many requests in rapid succession from the multiple client computer systems 201 and application servers 220.

Storage system 250 houses a plurality of databases corresponding with key elements of data preferable for a central product provider and veterinarians at their respective hospitals to generate product sales information from product item records selected from the master products database 251 for fulfillment to the hospital, or customer of the hospital, by the central product provider or pharmacy.

In accordance with the present invention, there is stored at the central product provider computer, otherwise known as the application server or servers 220, a master product database 251, a hospitals database 252, a customers database 253, a credit card wallet 254, an invoices database 255 and a taxes database 256. The master product database 251 comprises computer readable medium in which is stored a complete list of all products that individual hospitals may, or may not, choose to buy for their own account or offer for sale to customers. Each product item record in the master products database 251 is identified at least by a unique item ID and a wholesale price, but other information, such as SKU, description and other product related information may also be included.

### Databases and Data Structures

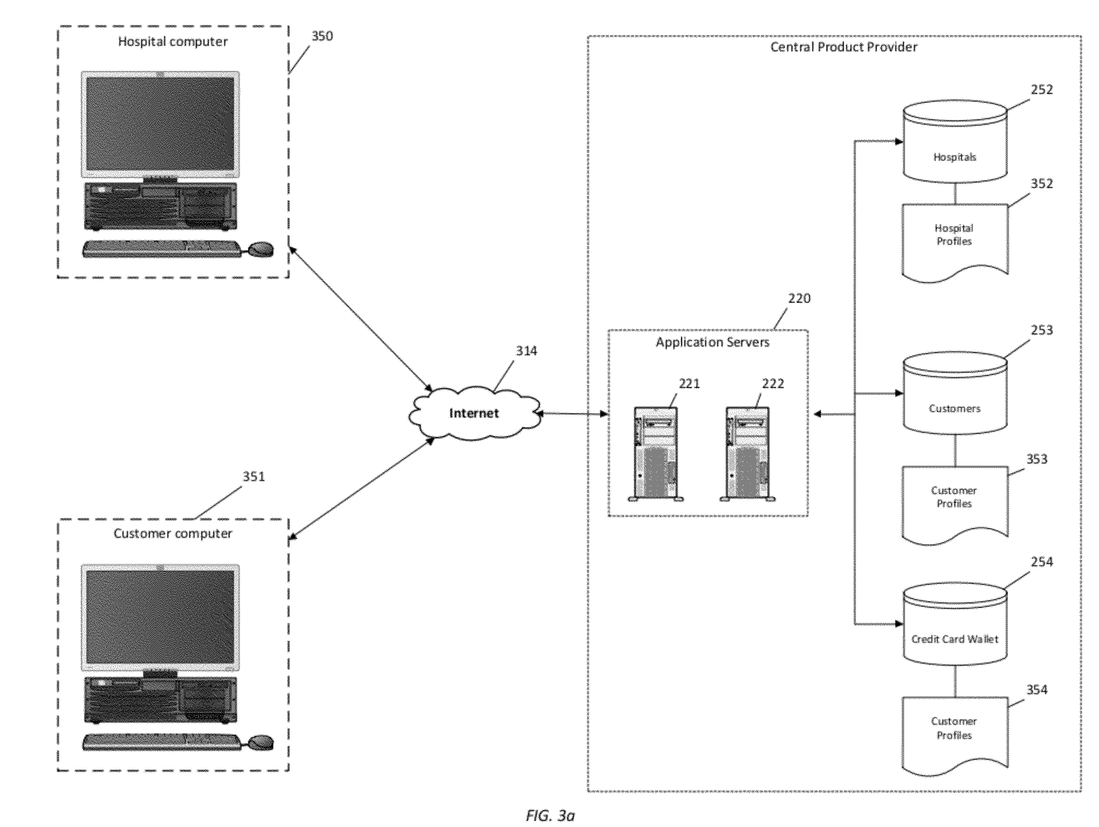

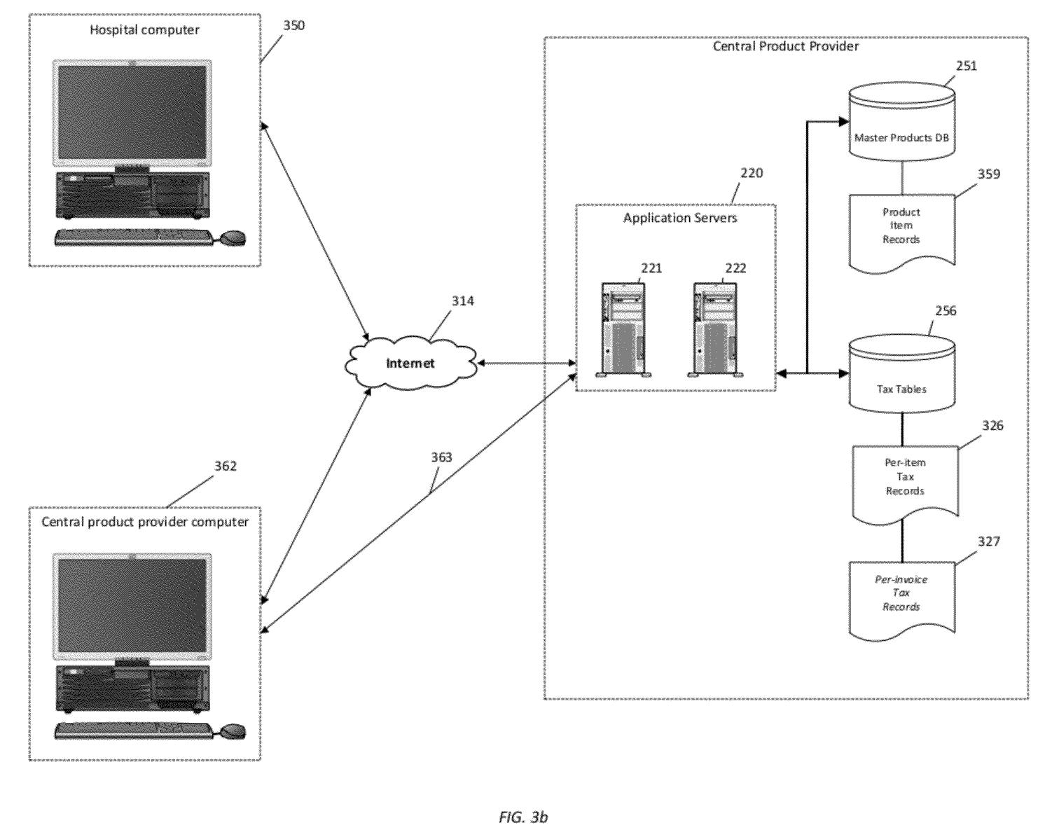

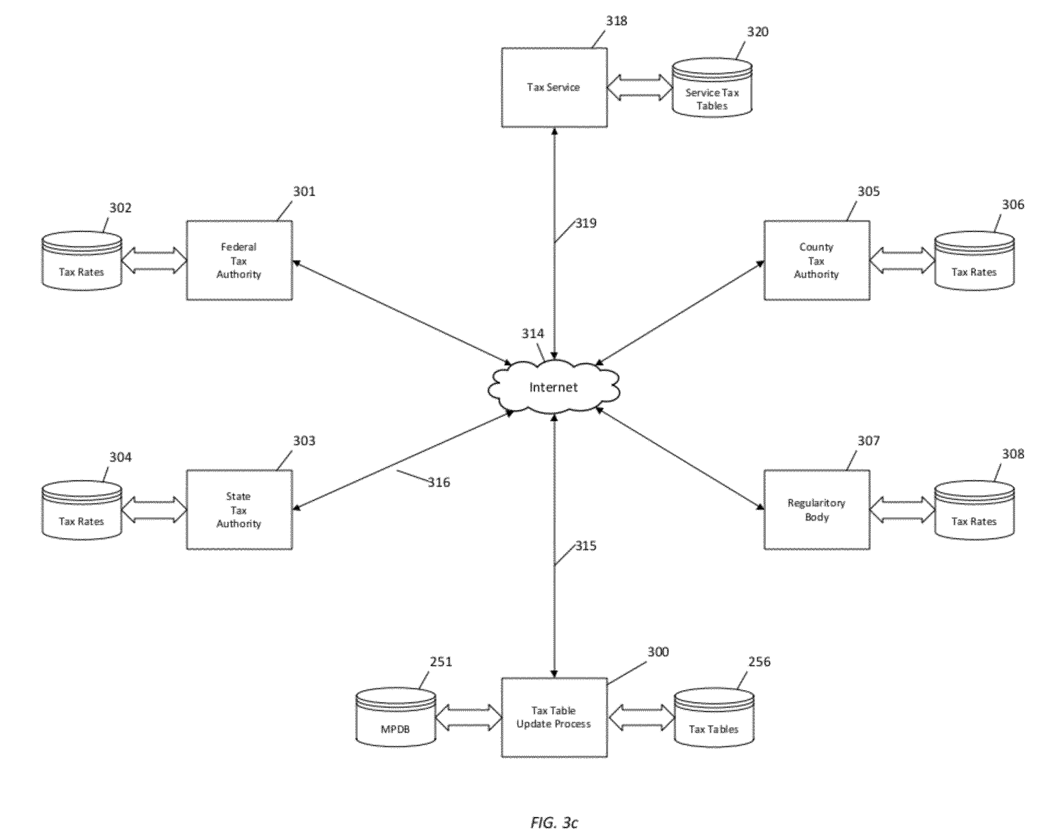

Referring also now to FIGS. 3a, 3b, 11, 12 and 13 the hospitals database 252 comprises a list of all member hospitals authorized to do business with the central pharmacy. In the hospitals database 252, each hospital's data preferably comprises the hospital's unique ID, contact information, and other relevant, hospital-specific information.

The customers database 253 comprises a computer-readable medium in which is stored a list of all member hospitals' customers authorized to do business with the central pharmacy. In the customers database 253, each customer's data preferably comprises the customer's unique ID, an associated hospital ID, customer contact information, and other relevant, customer-specific information.

The credit card wallet database 254 comprises a computer-readable medium in which is stored credit card information, for both hospitals and hospitals' customers, necessary for processing of payment for products with a credit or debit card. For each entry in the wallet there are listed a unique wallet ID, a hospital ID and a customer ID when necessary to process a payment from a customer. Further, it will be appreciated that it is advantageous to have backup credit card information for each hospital and customer in the database in the event that primary credit card information is outdated or otherwise ineffectual.

Invoice Record Detail

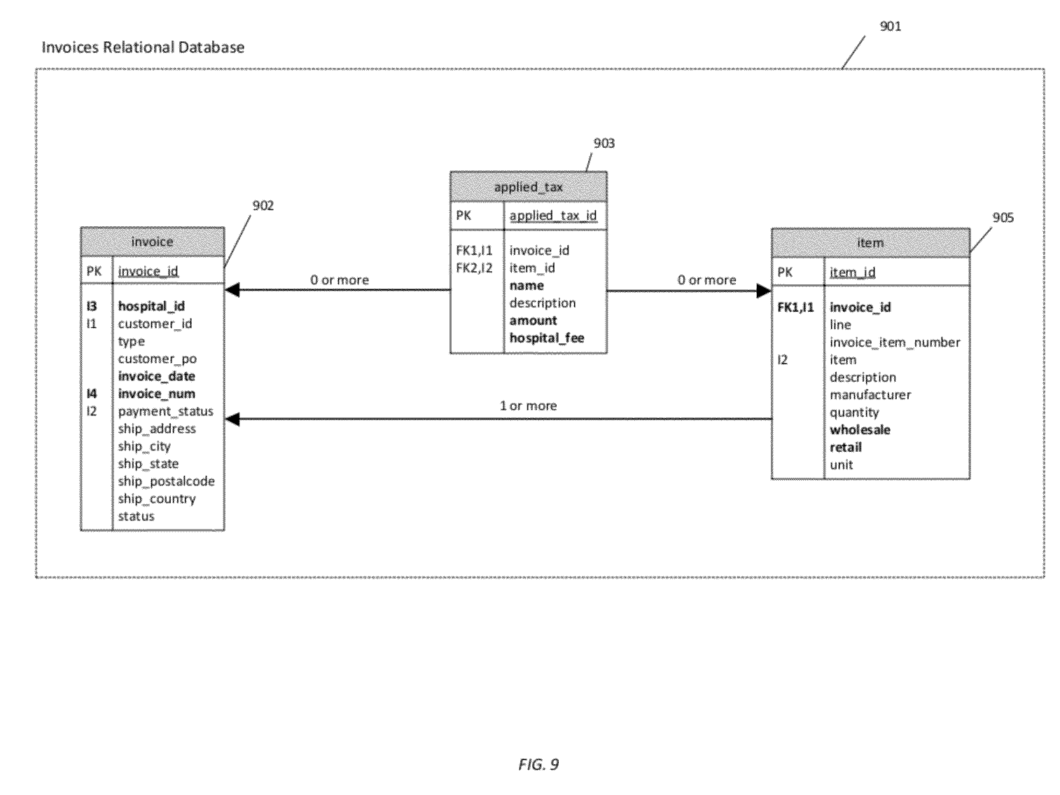

The invoices database 255 comprises a computer-readable storage medium for recording invoice records based upon product sale transactions between the central product provider and the veterinary hospital or its customers. As shown at FIG. 9, the database is a relational database comprised of the following three tables: invoice table 902, line item 905 and applied tax 903. Each invoice in the invoice table is identified by a unique invoice ID, each line item in the line item table 905 is identified by a unique line item ID and each applied tax in the applied tax table 903 is identified by a unique applied tax ID. The relationship between the tables is such that each entry in the invoice table, identified by its unique invoice ID, is related to one or more line items for that invoice, by the fact that the unique invoice ID occurs in the invoice ID field of the line item table of one or more line item records corresponding to those line items to be included on that invoice. Similarly, there are associated per-item and per-invoice taxes with each invoice as shown. This relationship is defined for per-item taxes by the instance of zero or more per-item taxes in the applied tax table 903 having a line item ID for the associated line item record on the invoice, signifying that there may be zero or more taxes associated with a particular line item record. Further, this relationship is defined for per-invoice taxes by the instance of zero or more per-invoice taxes in the applied tax table 903 having an invoice ID for the associated invoice record, signifying that there may be zero or more taxes associated with a particular invoice.

It will be appreciated by those of ordinary skill in the art that other taxes and required fees may be included as per-item taxes without departing from the true scope and spirit of the invention. In this sense, the term tax is used in a generic and broad form to include any required or mandated tax or fee to be paid to a third party such as a taxing or regulatory authority.

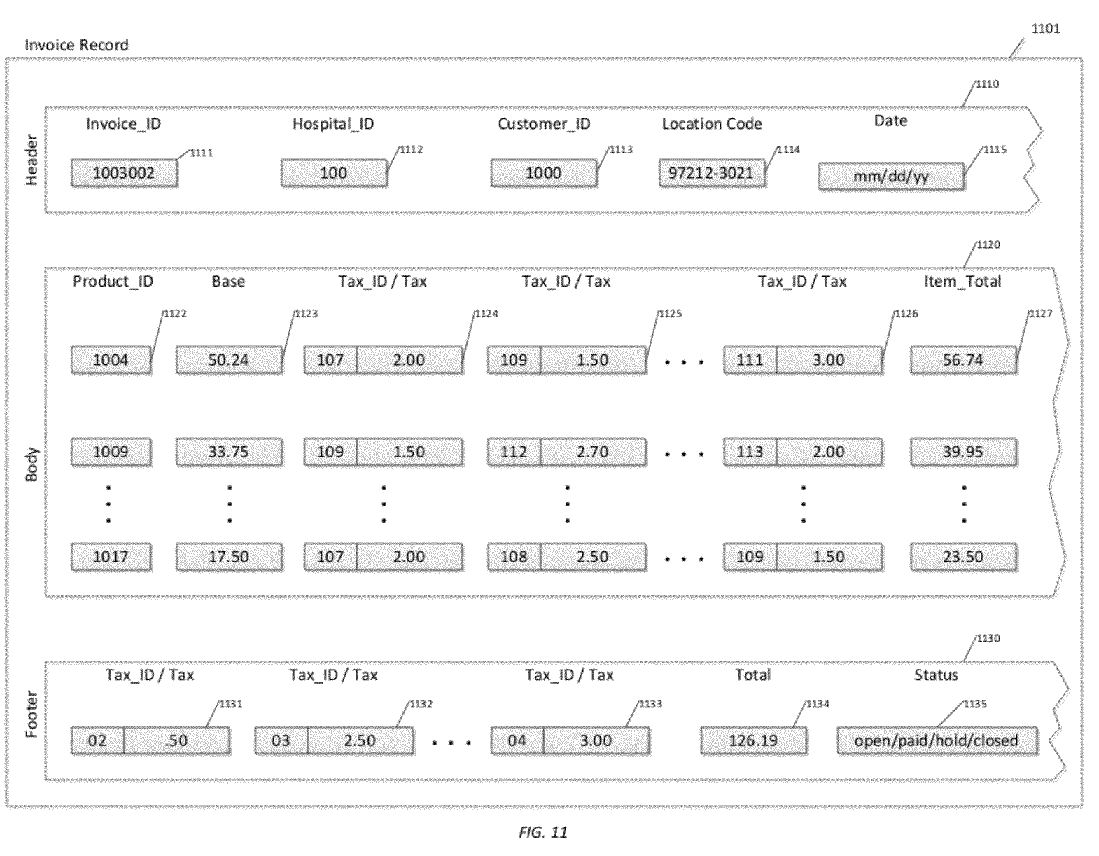

Referring to FIG. 11, there is shown a preferable embodiment of a memory data structure for an entire invoice record 1101. In the header portion 1110 of the record there is a unique invoice ID 1111, a hospital ID 1112, a customer ID 1113, a location code 1114 and a date 1115. The value in the location code may be a zip code, or similar designation, which identifies specific areas subject to tax by a particular authority, whether it be a city, a municipality or other local entity, a county, a state or a federal authority.

In a body portion 1120 of the invoice record 1101, there are one or more line item records, one line item record for each product to be purchased. Each line item record comprises a product ID 1122, wholesale price 1123, one or more per-item applied tax IDs and associated amounts 1124, 1125, 1126 and a product item total 1127.

In a footer portion 1130 of the invoice record 1101, there are one or more per-invoice applied tax IDs and associated amounts 1131, 1132, 1333, an invoice total 1134 and an invoice status field 1135.

Per-Item and Per-Invoice Tax Database and Product ID Detail

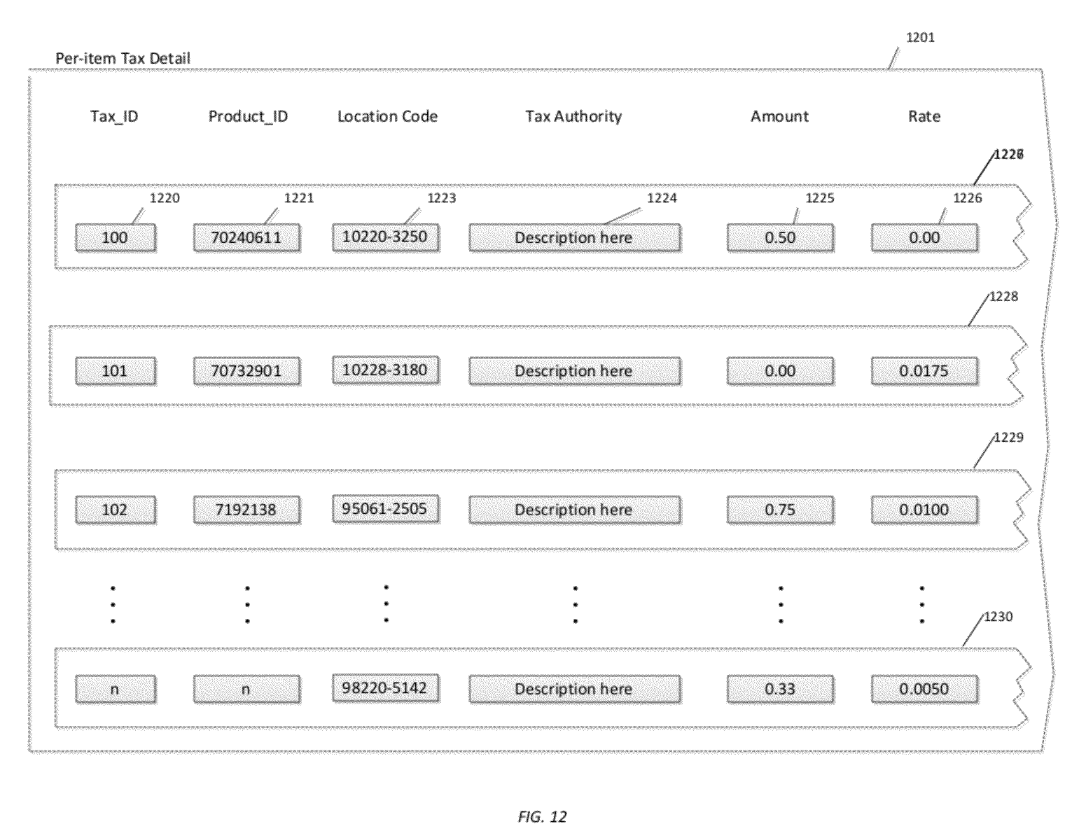

The tax database 256 comprises a computer-readable storage medium for storing per-item taxes and descriptions, as shown in FIG. 12, associated with each particular item in the master products database 251. Each per-item tax record 1227, 1228, 1229, 1230 in the tax database 256 comprises a tax amount field 1225 containing a value of zero or greater, a tax rate field 1226 containing a value of zero or a percentage/fraction tax rate, a unique tax ID field 1220, a product ID field 1221, a location code field 1223 and a tax authority description field 1224.

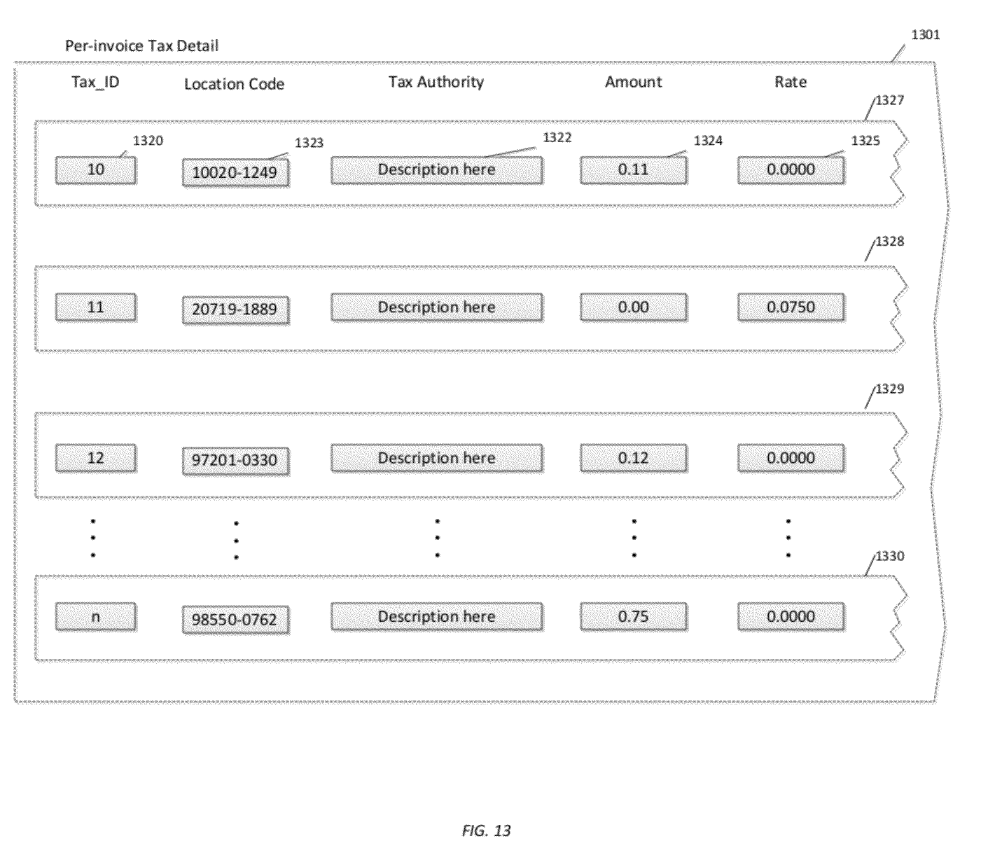

Further, the tax database 256 comprises a computer-readable storage medium for storing per-invoice taxes and descriptions, as shown in FIG. 13. Each per-invoice tax record 1327, 1328, 1329, 1330 in the tax database 256 comprises a tax amount field 1324 containing a value of zero or greater, a per-invoice tax rate field 1325 containing a value of zero or a percentage/fraction tax rate, a unique fee ID field 1320, a location code field 1323 and a tax authority description field 1322. In the preferred embodiment of the invention, the tax amount field 1324 would be zero when the per-invoice rate field 1325 contains a positive value. Conversely, when the tax amount field 1324 contains a positive number, the tax rate field 1325 would be zero. In other words, in most cases there will be either a fixed tax amount applied to an invoice or a rate, but not both. However, it will be apparent to those of ordinary skill in the art that both a fixed tax amount and a tax rate could apply in a given situation.

In a preferred embodiment of the invention, both per-item tax and per-invoice tax records are stored in the same tax table. What differentiates a tax record as a per-item tax is the presence of a product ID in the record. For per-invoice tax records, the product ID is zero or null in the record. Further, it will be appreciated by those of ordinary skill in the art that there are other ways to differentiate between these tax items in the same database. They may be separated into separate databases or other means of designating the difference may be employed without departing from the spirit of the invention as claimed.

It will be appreciated by those of ordinary skill in the art that there are several ways to identify a tax authority in the per-item tax and per-invoice tax database 256. As shown in the present embodiment of the invention, the tax authority description field 1124 contains data sufficient to identify which taxing authority is to receive taxes collected. However, it will be appreciated that a key could be used similarly to look up tax authority information in a separate tax authority database, not shown.

The hospital ID associated with each per-item tax and per invoice tax as shown in FIG. 11 is used for the purpose of later determination and accounting of tax proceeds paid by a central product provider to a particular veterinary hospital along the accounting information for remittance to a particular tax authority. Or alternatively, tax proceeds could be paid directly to the taxing authority. In either case, the invention enables the central product provider to provide ledgers and reports to hospitals and taxing authorities to assist with accounting for taxes collected and paid.

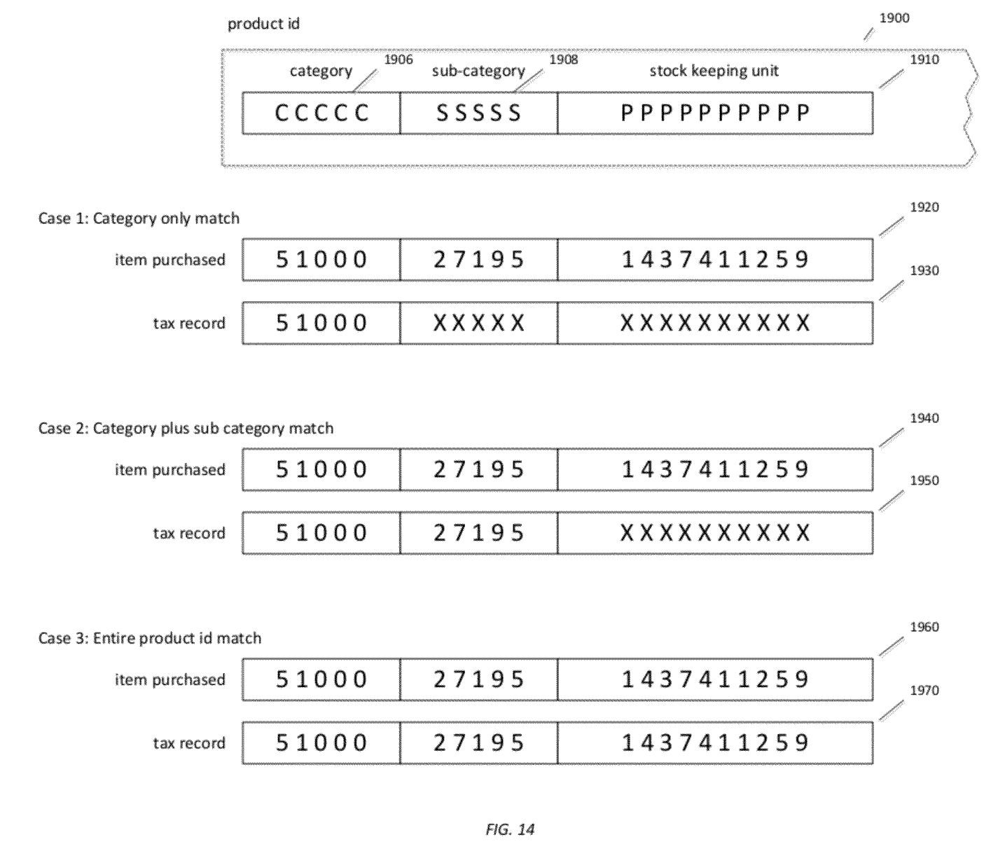

Referring to FIG. 14, a product ID 1900 is central to the lookup of taxes in a tax table that are associated with products to be sold. An example product ID is illustrated in FIG. 1 as a 20 character alphanumeric value which is comprised of the most significant, left most, characters representing a category of veterinary products, such as animal nutrition, animal equipment, non-prescription animal products such as supplements, or prescription animal products such as pharmaceuticals; the next most significant characters representing a subcategory, such as a subcategory antibiotics in the prescription category, or a durable subcategory in the animal equipment category; and the least significant, right most, characters representing a specific product within the category and subcategory, such as a particular product of heartworm medicine with a particular count, packaging and brand. As shown, the more specific portion of the product ID may be the product's stock keeping unit (SKU) number.

The methodology for searching tax tables is shown with three use cases in FIG. 14. In the first case, a category only match is illustrated wherein the first five digits of the product ID 1920 of the item purchased match the first five digits of the tax record product ID 1930, and the remaining digits of the tax record product ID are marked as wild cards denoted with an “X”, meaning they match any possible characters in the product ID of the item purchased. Thus, this case illustrates how a tax record in the table is located and determined in accordance with a category of products. For example, if the product purchased is a one month supply of particular brand heartworm medication 10 mg, and the category of products is pharmaceuticals, then a match with tax record is made assuming the location codes of the tax record and the customer purchasing the product also match.

Since a product subcategory may be used to further differentiate applicability of a certain tax, case number two illustrates how, in addition to the above-described matching methodology, a match of subcategory characters in the relevant product ID's of the item purchased and the tax record may further be used to determine a match to determine applicability of such a tax. As with the first case, wild cards in the tax record's specific product ID field indicate that any characters in that portion of the product ID of the item purchased will provide a match such that any product falling into the category and subcategory for which the tax applies will be taxed, assuming the location code of the customer making the purchase matches the location code contained in the tax record.

Similarly, a product ID in the tax record contains an exact match for all characters in the product ID for the item purchased, indicating a specific product tax is applicable to the product purchased.

The search methodology described above is employed every time an is selected for display so that taxes may be calculated and included in the offered purchase price. It will be appreciated by those of ordinary skill in the art that other methods of determining matching product ID's or matching location codes may be employed, as known in the art, without departing from the true scope and spirit of the invention.

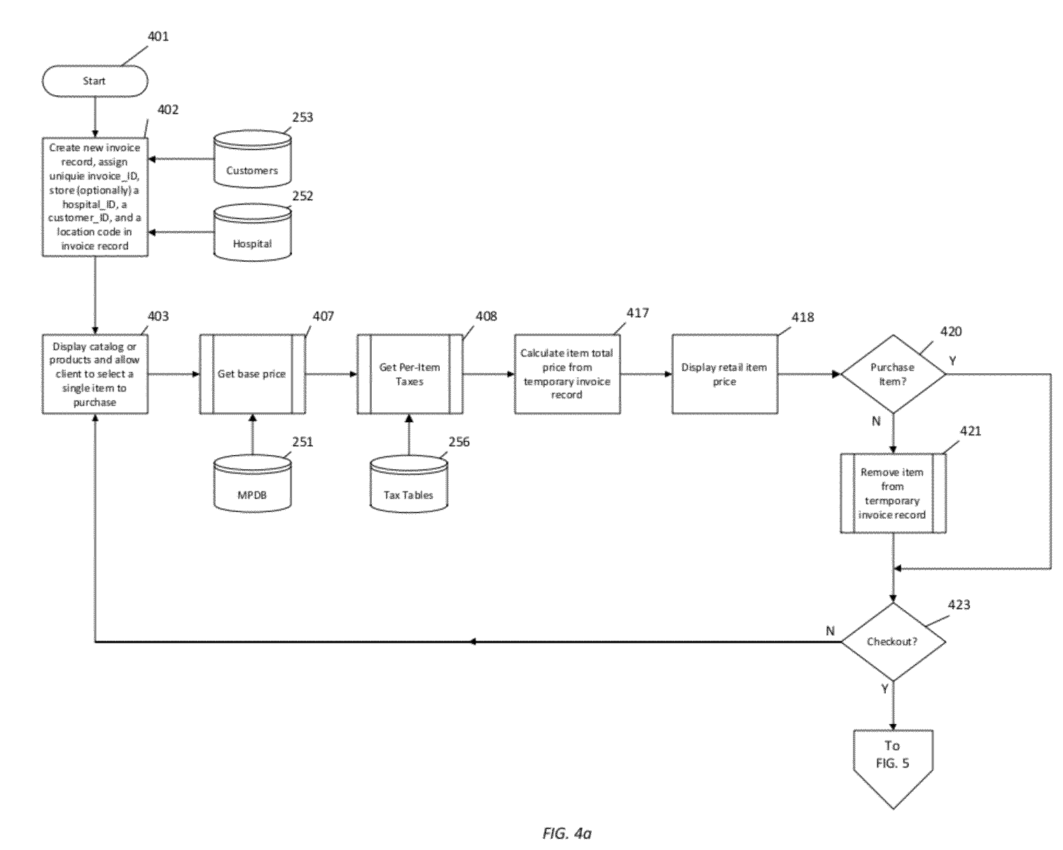

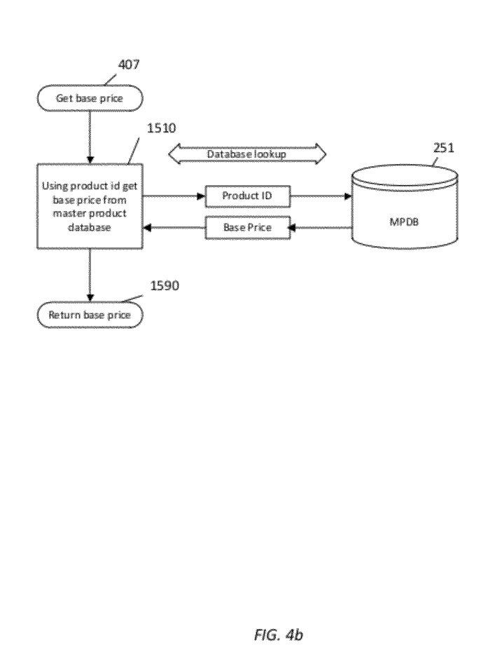

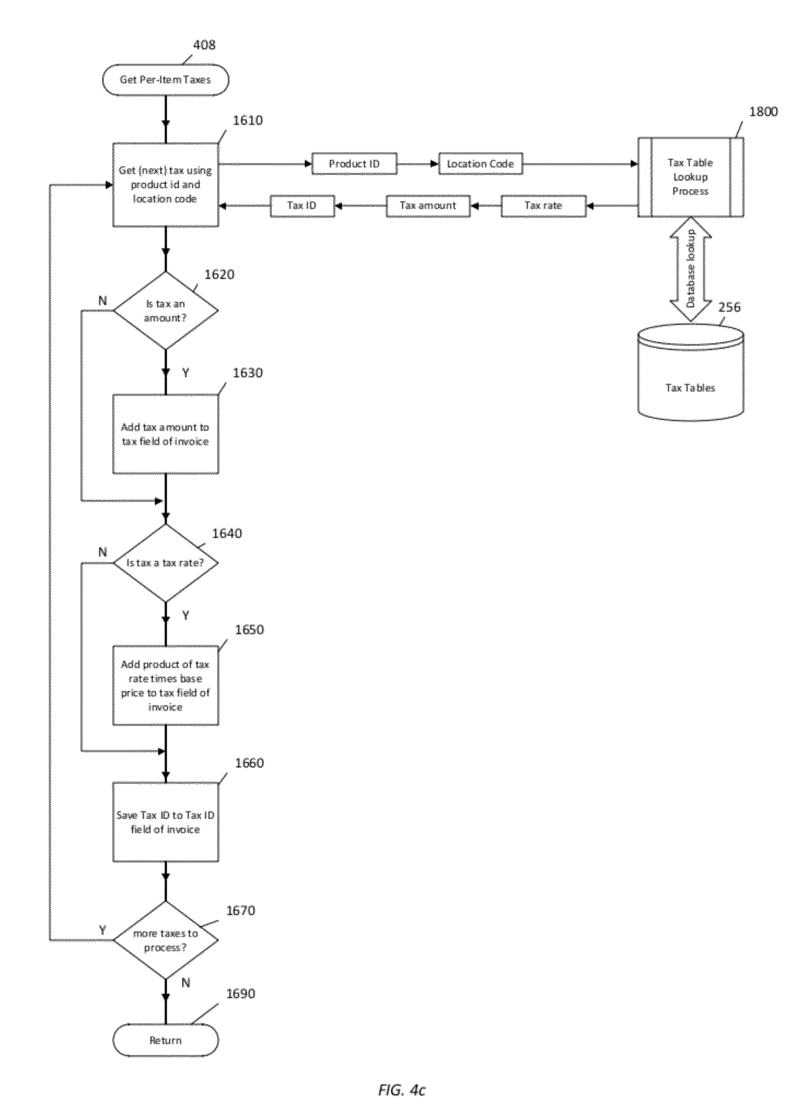

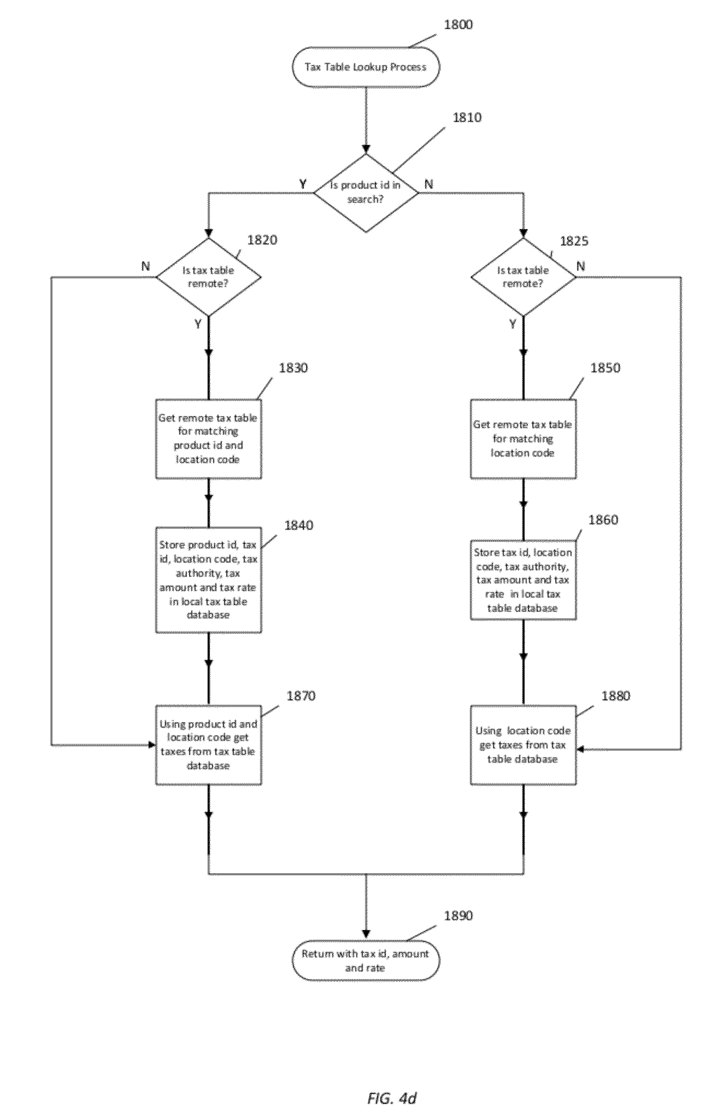

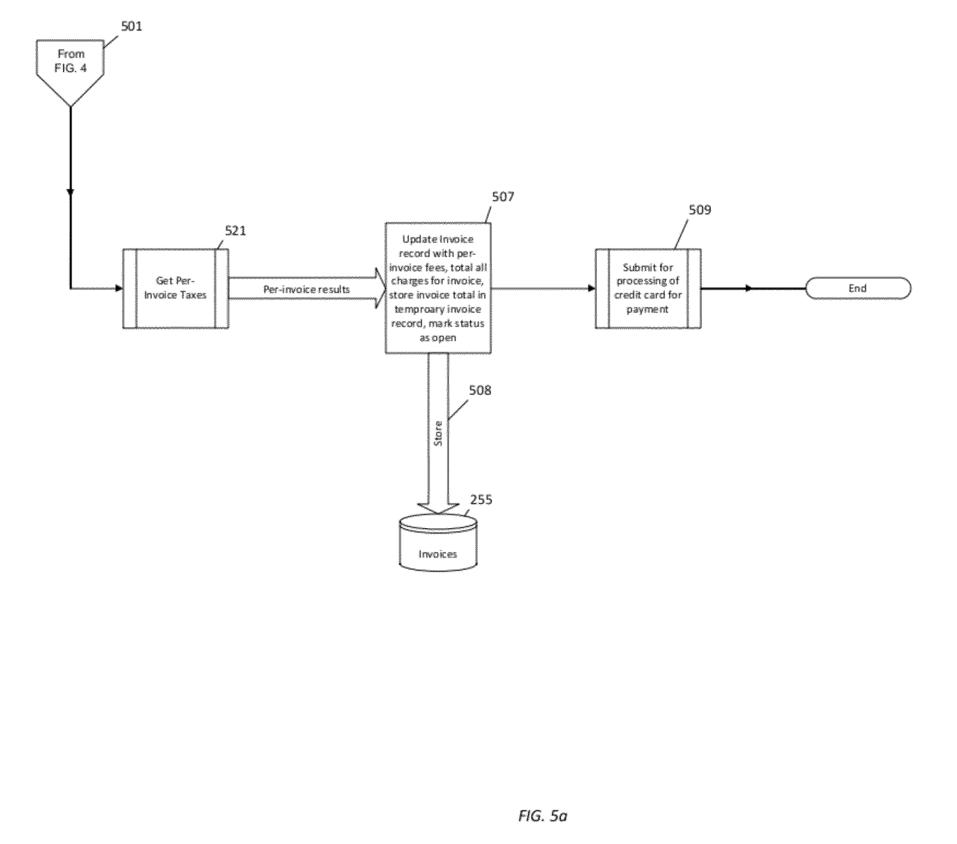

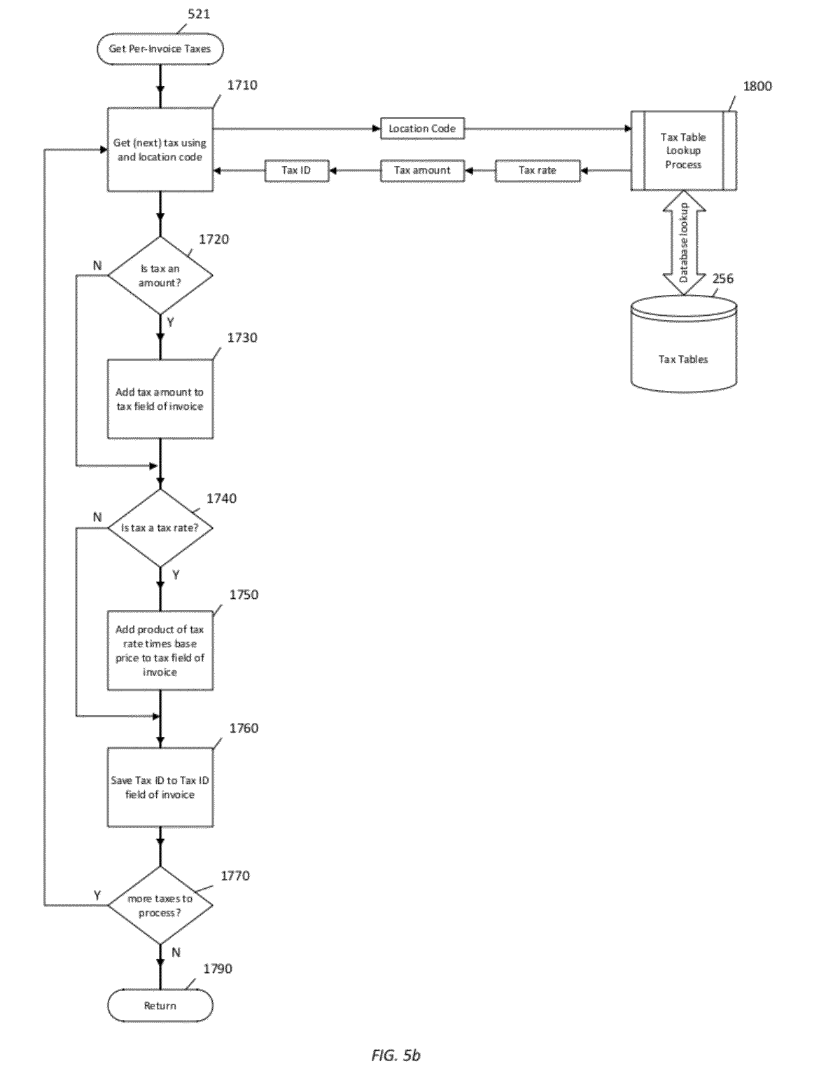

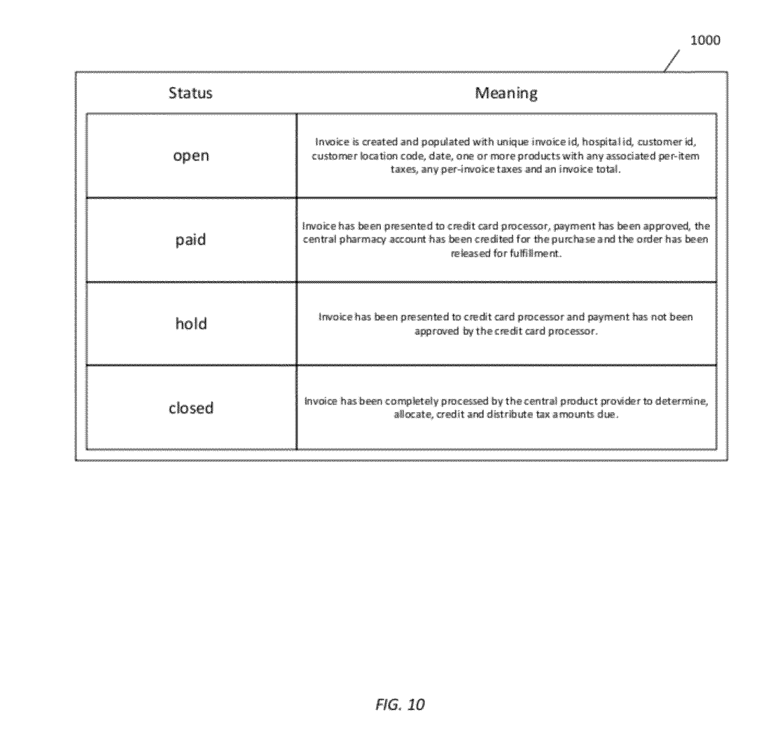

Referring to FIG. 10, there is shown a table 1000 describing the various status options for the status field 1135 of an invoice record 1101 (see also FIG. 11). The status field 1135 is set to open when the invoice is first created and populated with a unique invoice ID, hospital ID, customer ID, customer location code, date, one or more product items with any associated per-item taxes, any per-invoice taxes and when the invoice is totaled all as accomplished as shown on FIGS. 4 and 5.

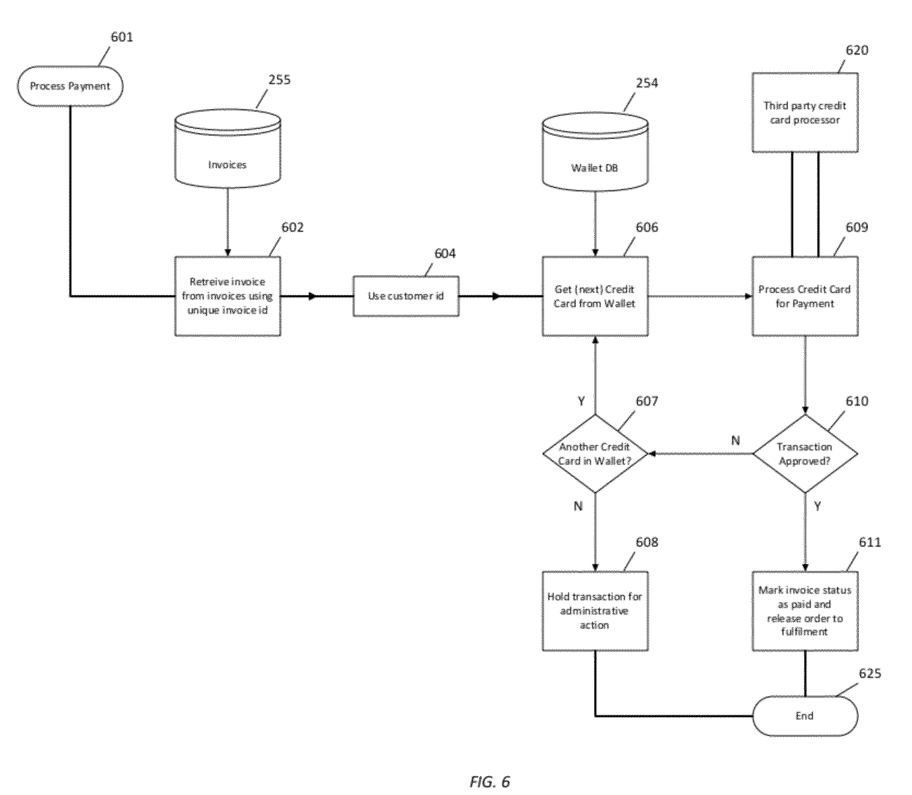

The status field 1135 is set to paid when the invoice has been presented to a credit card processor, payment has been approved by the credit card processor, the central pharmacy account has been credited for the purchase and the order has been released for fulfillment all as accomplished at 611 on FIG. 6.

The status field 1135 is set to hold when the invoice has been presented to a credit card processor and payment has not been approved by the credit card processor as shown at 608 on FIG. 6.

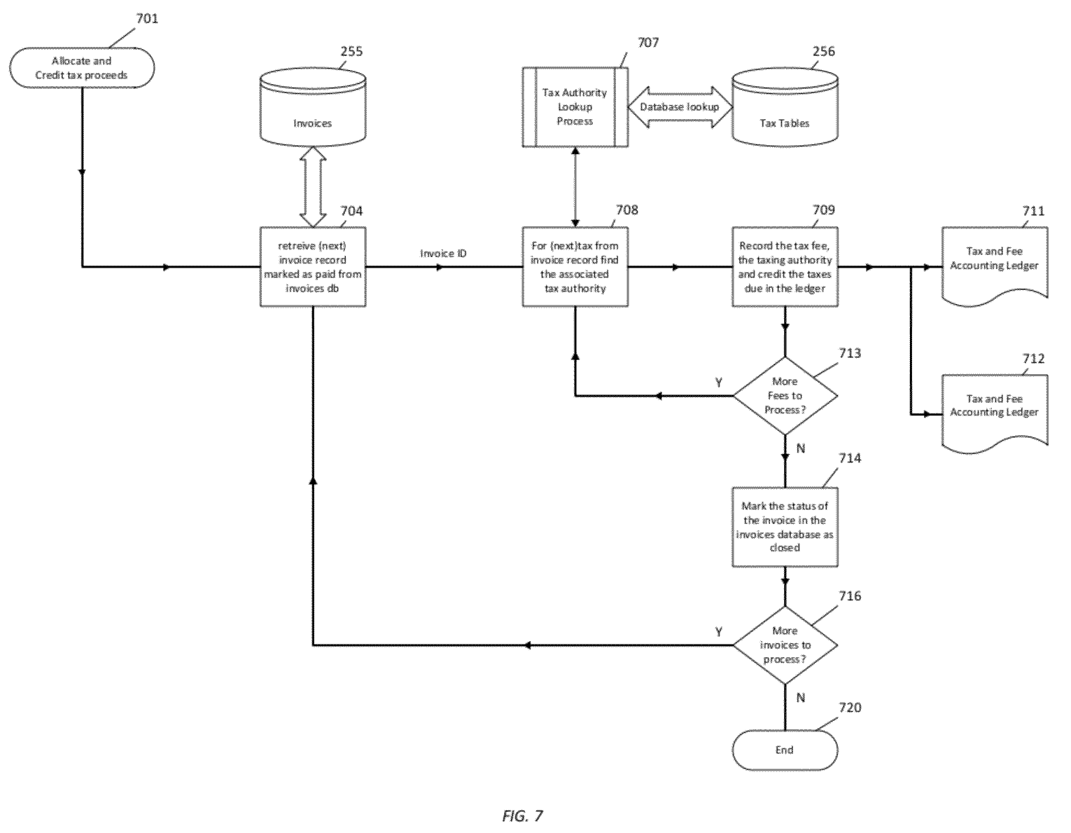

The status field 1135 is set to closed when the invoice has been completely processed by the central product provider to determine, allocate, credit and distribute amounts due to the hospital account or tax authority as a result of the sale transaction as shown at 709, 711, 712 and 714 on FIG. 7.

### Tax Application and Tax Proceeds Distribution Processes

Member Profile Creation and Maintenance

Referring now to FIGS. 3a-3d a computer-enabled method and system for automated application, determination and distribution of taxes and fees on the sale of products for animals is disclosed, wherein the method allows subsequent recovery of historical taxing information by the central product provider for subsequent tax proceeds distribution to a veterinary hospital for remittance to a taxing authority, or alternately, directly to a taxing authority on behalf of a veterinary hospital.

In FIG. 3a there is shown a hospital computer 350 for communicating over the Internet 314 with application servers 220 which in turn comprise or communicate with databases 252, 253, 254 for a central product provider, such as a central veterinary pharmacy. Veterinary hospital member account details, such as veterinary hospital membership profiles 352, are asynchronously created, stored and maintained in the computer readable medium of the hospital's database 252 and are identified by a unique hospital ID. Customer account details, such as customers' membership profiles 353, are asynchronously created, stored and maintained in the customers database 253 computer readable medium and are identified by a unique customer ID. Credit card information profiles 354 for both hospitals and customers are asynchronously created, stored and maintained in the credit card wallet database 254 computer readable medium and are identified by a unique credit card wallet ID.

As is customary in the art, it is contemplated that each hospital and customer may preferably have more than one credit card information profile 354 in the credit card wallet database 254 associated with their hospital profile 352 or customer profile 353, respectively. Each hospital account credit card profile 354 in the credit card wallet database 254 is related to a hospital profile 352 by the presence of a hospital ID in the credit card profile. Similarly, each customer account credit card profile 354 in the credit card wallet database 254 is related to a customer profile 353 by the presence of a customer ID in the credit card profile. If a customer attempts a products purchase transaction without at least one valid credit card information profile, the transaction would be denied.

FIG. 3a also shows a customer computer 351 for communicating over the Internet 314 with the central product provider application servers 220 during those transactions where a customer purchases product directly over the Internet from a home computer via a website hosted for the customer's hospital by the central product provider servers 220.

Tax Records Creation and Maintenance

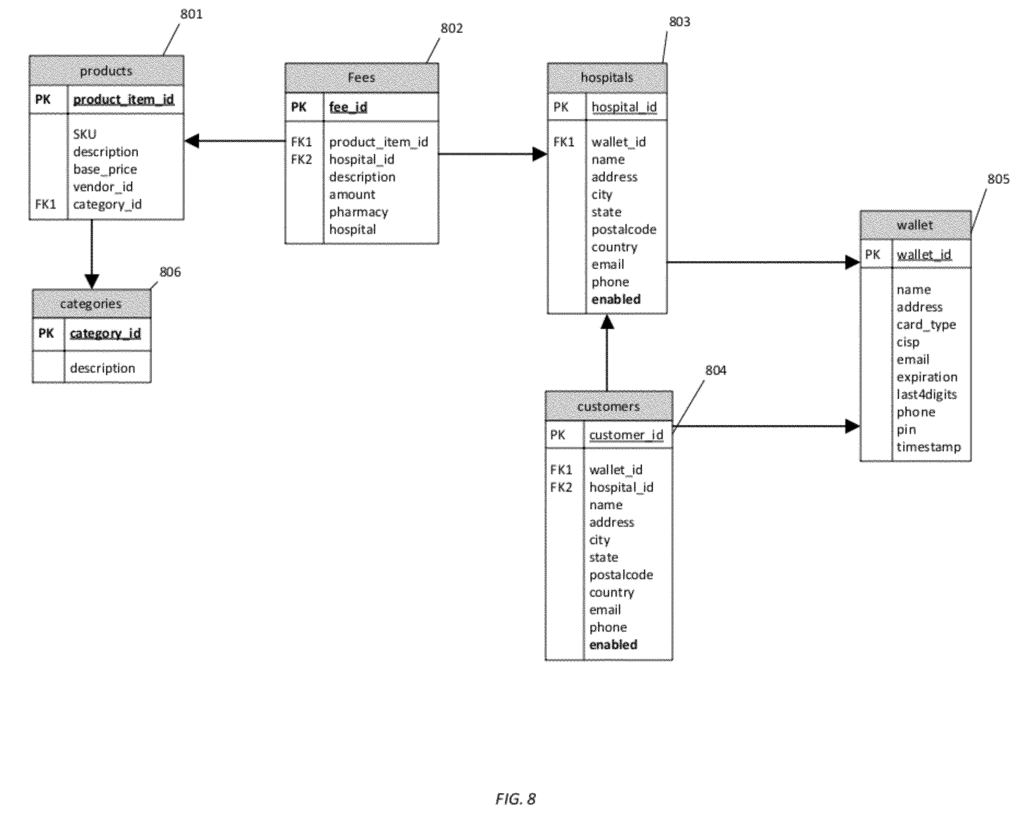

Referring to FIG. 3b, there is shown the hospital computer 350 for communicating over the Internet 314 with computer application servers 220 for the central product provider, having asynchronously created, stored and maintained thereon in a computer readable medium a tax tables database 256 containing a plurality of per-item tax records 326 and per-invoice tax records 327, each comprising individual per-item tax records and individual per-invoice tax records. The application servers 220 also communicate with the master products database 251 having stored thereon a plurality of product item records 359, each item record being identified by a unique product ID as shown in FIG. 8. Referring to FIG. 12, a plurality of example per-item tax records 1201 is shown. The example per-item tax records 1227, 1228, 1229, 1230 are associated with product item records 359 in the master products database 251 by the presence of a product ID in each per-item tax record. As shown in FIG. 12, each per-item tax record 1227, 1228, 1229, 1230 comprises at least a unique tax ID 1220, a product ID 1221, a location code 1223, a tax authority description 1224, a tax amount 1225 and a tax rate 1226.

Further, FIG. 3b shows a central product provider computer 362 for communicating over the Internet 314, or over a direct internal network connection 363, with the central product provider application servers 220 for the purpose of creating and maintaining the tax tables database 256 and the master products database 251 as well.

If there is no tax record for a particular product and associated location code in the tax database, the process of invoicing for that item will proceed with no taxes being applied. Similarly, if there is no tax record for a particular invoice and associated location code in the tax database, the process of invoicing for that invoice will proceed with no per-invoice tax being applied to the invoice. The presence of taxes in the tax tables database 256 determines whether a tax is applied to a product or invoice or not. This fact accommodates a simplified system for dynamically updating the tax tables database 256, whether it be for per-item taxes or per-invoice taxes, at any time, for future application to sold products and invoices. Upon adding a new tax to the tax tables database 256, or otherwise updating the tax tables database, the updated information is then available for the system to automatically apply the updated tax during the very next product sale transaction accomplished in accordance with the method of the invention.

Likewise, modification or removal of taxes in the tax tables database 256 have a similar dynamic and automatic effect on product sales and subsequent tax proceeds allocation and distribution.

Tax Table Update

In FIG. 3c, a tax tables database update process 300 in the central product provider computer 220 (see FIG. 3b) interacts with the computer readable medium of the tax tables database 256 to build and asynchronously update the plurality of per-item and per-invoice tax records in the database. To initialize the tax tables database 256, a system administrator may be charged with collecting electronic tax data, or creating the same, and manually entering the data into the system in the form of per-item and per-invoice tax records. To the degree that a particular taxing authority provides electronic tax tables which match the classifications of products and geographic location codes to the same extent as used in the system, this process is simplified. However, to the degree that there are differences between the product identifications and geographic location codes, the system administrator would be charged with reconciling the differences during initialization.

The per-item and per-invoice taxes preferably comprise at least one of the following state, county, city, and other local animal product sales taxes: nutrition, equipment, prescription, pharmaceutical, non-prescription and over-the-counter. Alternately, any federal tax would be easily accommodated by the invention.

Both the per-item and per-invoice tax records include a location code which is used to match with a location of a customer to determine whether a particular tax applies to the product, or even services, sale. Further, the per-item taxes are determined by both a product ID and a location code in accordance with a category of products, a subcategory of products or an individual product. It will be appreciated by those of ordinary skill in the art that other required taxes and fees may be included as per-item and per-invoice taxes without departing from the true scope and spirit of the invention.

Referring to FIG. 3c, in a first embodiment, a tax service 318 calls various taxing authorities over the Internet in order to initialize, modify and update, asynchronously or in batch process, tax tables 320 maintained by the tax service. Thus, the tax service 318 asynchronously and continuously updates the tax tables database over the Internet 314 by retrieving tax data from tax authority provided tax tables 302, 304, 306, 308 from tax authorities 301, respectively. With this embodiment of the invention, the tax table update process 300 at the central product provider accesses tax service 318 as needed to obtain tax information for sales in progress. Alternatively, however, the tax table update process 300 may preferably access tax authorities 301, 303, 305, 307 directly for establishing and refreshing a local tax table database 256. Still further, a combination of tax service 318 and direct tax authority access may be employed. Thus, after the system has been initialized with tax data as described, the update process 300 may periodically update the tax tables database 256 over the Internet 314 to reflect interim changes in taxes and required fees. This process may be performed asynchronously, at periodic intervals, or an as needed basis and/or in conjunction with look up of taxes to be applied to the sale of a product.

Per-invoice tax record updates to the tax table database 256 are accomplished by accessing a particular tax authority for a given region and downloading the tax authority's most recent tax tables or data. Thus, for example, the tax tables of a particular state, county or city, as indicated by its location code, or codes, may be transferred into the tax tables database 256 on an asynchronous, batch process or as-needed basis to update the database.

Similarly, per-item tax record updates, if any, for each particular product item, as indicated by product IDs, and in accordance with a particular location, as indicated by the tax authority's region and the corresponding tax record's location code, are accomplished by accessing a particular tax authority for the relevant location and downloading the tax authority's most recent tax tables and/or tax data associated with that product. Since taxing authorities tax products by means of general classification systems, the database makes use of the category portion 1906 or other classification code of the product ID 1900.

Thus, the tax table update process 300 obtains taxes and maintains tax tables by accessing a tax service and/or taxing authorities, whether they be federal, state, county or local authorities, to retrieve and store relevant tax data in accordance with location codes that uniquely identify the geographic extent of each taxing authority implicated in a transaction. For example, the tax table update process 300 directs a request 315, 316 via the Internet 314, to the tax service 318 or a particular tax authority (for example a county tax authority 305). Responsive to a request for per-invoice tax records, the tax authority 305 provides current per-invoice tax rates and/or amounts for the relevant countywide geographic location, and they are applied to the transaction and/or transferred to the tax tables database 256 via the Internet 314. Similarly, responsive to a request for per-product tax records, the tax service 318 or for example county taxing authority 305 provides current per-product tax rates and/or amounts by category, subcategory and/or product item type and relevant countywide geographic location, and they are applied to the transaction and/or transferred to the tax tables database 256. Thus, generally speaking the tax table update process 300 uses just the customer location code to determine applicable per-invoice taxes, while it uses both the location code and the product ID, or at least part thereof, to determine applicable per-item taxes.

Using this method, the tax tables database update process 300 updates the master tax tables database 256 with current tax amounts and/or rates from the tax service 318 and/or taxing authorities. Thus the updated current taxes will be applied immediately on the next invoice for sale of a product to a hospital or customer of the hospital. Further, applicable taxes applied to prior transactions will also be saved by the system of the invention, as an invoice snapshot, to allow subsequent accurate accounting for and payment of taxes collected, regardless of when they were collected.

Per-Item Tax Aggregation Phase

Referring now to FIGS. 4a-4d, a per-item tax aggregation phase is shown wherein a hospital or customer requests product information for selection and purchase from the central product provider via a hospital computer, or in the case of a web-based purchase via a customer home computer (hereafter referred to as the “client computer”), thus initiating a product selection, pricing, invoicing and sale process at 401. In response to the information request from the client computer, at 402 a new invoice record (see 1101 in FIG. 11) comprising a unique invoice ID 1111, an associated hospital ID 1112, an associated customer ID 1113 and a customer location code 1114, determined from the customer's address in the customer's profile, is created in an invoice record in temporary computer readable medium or memory. If a hospital is not involved, such as in a pet supplement purchase from a pet food supplier not requiring a prescription, a hospital ID would not be necessary. Also, responsive to the information request, a catalog display of at least one product item, but preferably a plurality of product items, is provided by the central product provider computer to the client computer to allow a user at the client computer to select a single product item for review and possible purchase as shown at 403.

Responsive to the selection of an item from the catalog, the item's product ID and the customer's location code are used by a get base price subprocess 407 shown in greater detail in FIG. 4b. The get base price subprocess 407 uses the product ID to get the base price of the product from the master products database 251 and returns the base price to the calling process. The get per-item taxes subprocess 408 next uses the product ID and the customer location code to find any taxes applicable to the product at the customer's location.

As shown in greater detail at FIG. 4c, the get per-item taxes subprocess 408 uses the product ID and customer location code in calling a tax table lookup process 1800, further described below in connection with FIG. 4d, to look up the next tax applicable to the product at the relevant location as shown at 1610, and as a result for a found tax item there is returned into temporary computer readable medium a tax ID, a tax amount and a tax rate. At 1620, the get per-item taxes subprocess 408 determines whether the retrieved value of the tax amount field is greater than zero indicating an applicable tax amount. If the tax amount is greater than zero, the amount is added to the tax field (e.g., 1124) as shown at 1630 and the process continues at 1640. If the value is zero, execution is passed to 1640 to check for a tax rate. At 1640, any tax rate retrieved in 1610 is examined to see if it has a positive value. If the value is positive, the product of the tax rate times the base price is added to the tax field of the invoice for the product in question. If the value in the tax rate field is zero, the process continues at 1660 where the tax ID is saved to the tax ID field 1124 of the invoice for the product in question. At 1670 the subprocess determines if there are any more taxes to be added for the product in question. If any additional taxes are found, the subprocess continues execution at 1610. When there are no more per-item taxes to be applied, the subprocess returns control to the calling process at 1690. For each time an additional tax is added in FIG. 4c, a new tax ID/tax pair is added to the invoice for the relevant product item as shown at 1124, 1125, 1126 of FIG. 11.

At process box 417 of FIG. 4a, the item total price is calculated by adding the base price and the tax field of all applicable taxes previously determined and added to the invoice, and the item total is stored in the item total price field 1127 of the invoice record. The retail item price of the product is displayed for the customer with a purchase prompt at 418. The customer is given the option to purchase the item as shown at 420, and if the customer chooses to not purchase the item at 421, the item is removed from the temporary invoice record. Whether the customer wishes to purchase the item or not, the customer is asked if they would like to check out, indicating they are finished adding items to the invoice. If the customer chooses not to check out at 423, process control is returned at 403 to allow selection of another product. If the customer chooses to check out at 423, the system continues as shown at FIG. 5a to determine and apply per-invoice taxes. At 521 control is passed to the get per-invoice taxes subprocess shown in further detail on FIG. 5b.

Per-Invoice Tax Aggregation Phase

Referring now to FIGS. 5a and 5b, once all product items and associated per-item taxes have been applied to the invoice, signified by the customer selecting “Checkout” at 423 on FIG. 4a, the system continues to add any per-invoice taxes to the invoice at subprocess 521.

As shown at the get (next) tax box 1710 of the get per-invoice tax subprocess 521, the subprocess 521 uses the customer location code to call the tax table lookup process 1800 to look up the next per-invoice tax applicable to the invoice for the relevant location, and as a result for a found tax item there is returned into temporary computer readable medium a tax ID, a tax amount and a tax rate. At 1720, the get per-invoice taxes subprocess 521 determines whether the retrieved value of the tax amount field is greater than zero indicating an applicable tax amount. If the tax amount is greater than zero, the amount is added to the tax field (e.g., 1131) as shown at 1730 and the process continues at 1740. If the value is zero, execution is passed directly to 1740 to check for a tax rate. At 1740, any tax rate retrieved in 1710 is examined to see if it has a positive value. If the value is positive, the product of the tax rate times the total invoice price is added to the tax field of the invoice for the invoice. If the value in the tax rate field is zero, the process continues at 1760 where the tax ID is saved to the tax ID field 1131 of the invoice. At 1770 the subprocess determines if there are any more taxes to be added for the invoice. If any additional taxes are found, the subprocess continues execution at 1710. When there are no more per-invoice taxes to be applied, the subprocess returns control to the calling process at 1790. For each time an additional per-invoice tax is added in FIG. 5b, a new tax ID/tax pair is added to the invoice as shown at 1131, 1132, 1133 of FIG. 11.

Referring again to FIG. 5a, after all per-item and per-invoice taxes and fees have been added to the temporary invoice, the total of the invoice is calculated at 507 and the total is stored in the invoice total field 1134. Further, the entire invoice is moved at 508 from temporary computer readable medium to the more permanent storage of invoices database 255. The invoice status is marked as open at 507 and the invoice is submitted for credit card processing at 509.

Referring now to FIG. 4d in further detail, the tax table lookup process 1800, called from either the get per-item taxes subprocess 408 of FIGS. 4a and 4c, or the get per-invoice taxes subprocess 521 of FIGS. 5a and 5b, determines at 1810 if a product ID is included in the search request indicating a per-item tax is to be obtained, or if no product ID is included in the search request, indicating a per-invoice tax is to be obtained. If a product ID is passed from the calling process, execution continues at 1820 to determine whether a remote tax service provider, such as tax service 318, is available. If so, execution continues at 1830 to determine whether there are taxes in the remote tax table which match the provided location code and product ID. Continuing at 1840, if a matching tax record is found, the record, comprising the product ID, the tax ID, the location code, the tax authority, the tax amount and tax rate, are cached in the local tax table database 256 as shown on FIG. 4c for later reference. In either case, whether a remote tax service provider is available or not available, or otherwise not indicated, at 1870 the product ID and location code are used to get from the tax tables database 256 the tax id, the tax amount and the tax rate which are returned to the calling process at 1890.

If a per-invoice tax is to be obtained, as when decision diamond 1810 determines that no product ID is included in the search request, execution continues at 1825 to determine whether a remote tax service provider, such as tax service 318, is available. If so, execution continues at 1850 to determine whether there are taxes in the remote tax table which match the provided location code. Continuing at 1860, if a matching tax record is found, the record, comprising the tax ID, the location code, the tax authority, the tax amount and tax rate, are cached in the local tax table database 256 as shown on FIG. 5b for later reference. In either case, whether a remote tax service provider is available or not available, or otherwise not indicated, at 1880 the location code is used to get from the tax tables database 256 the tax id, the tax amount and the tax rate which are returned to the calling process at 1890.

Payment Processing Phase

Referring now to FIG. 6, given a unique invoice ID from the selection process described above and indicating the invoice to be processed for payment, there is shown the method for processing credit card payments. The method retrieves the invoice for processing from the invoices database 255 using the invoice ID as shown at 602. The customer ID from the retrieved invoice is used to identify the customer responsible for the transaction as shown at 604. The customer ID is used as shown at 606 to retrieve a next customer credit card from the wallet database 254 to fund the transaction. The wallet database 254 contains at least one set of credit card processing information for each customer in the system.

At 606, the method accesses the wallet database 254 and returns into computer readable memory the next entire credit card record for the subject payor, and attempts processing the payment for the invoice total at 609 by accessing a third party credit card processing financial institution 620 over the Internet, phone line or other remote network connection. If the transaction is not approved 610, control is passed to decision logic 607 to determine whether there exists another credit card in the wallet database 254 for the subject payor. If no additional credit card is found, the transaction is not approved for purchase and is placed on hold, by changing the status of the invoice to hold, for administrative action as shown at 608. If another card is found at 607, control is returned again to 606 to repeat of the steps of the method with respect to the newly found credit card for processing. If the transaction is approved at 610, payment is made, the invoice marked as paid by changing the status of the invoice to paid and the order is released to fulfillment.

Tax Proceeds Allocation, Crediting and Distribution Phase

Referring now to FIG. 7, the tax proceeds allocation and crediting method beginning at 701 may be performed at any chosen time, whether randomly or periodically, such as daily, weekly, monthly, quarterly or other designated period. The method continues by retrieving from the invoices database 255 into temporary computer-readable medium at least part of an invoice record marked as paid as indicated in the status field of the invoice record and containing the unique invoice ID, the customer ID, the at least one tax ID and associated tax amount. To accommodate the processing of all taxes in the retrieved invoice record, a loop 708, 709, 713 is employed that processes the taxes sequentially until all of the taxes of the invoice record have been processed. As shown at 708, the tax authority lookup process uses each tax from the invoice record to find a corresponding tax record in the tax tables database 256 which contains a match of the tax ID of the invoice record in temporary memory. Upon finding the matching tax record in the tax tables database 256 there is retrieved the associated tax authority identification from the tax authority description field 1224, 1322 (FIGS. 12, 13 respectively) of the matching tax record in the tax tables database 256. The method then credits the tax due in a tax accounting ledger 711, 712 and records the appropriate tax authority to which the tax is payable. This information is able to be used later in a report given to the veterinary hospital in advising to whom the taxes collected are to be paid.

The invoice record in computer-readable medium is checked at 713 to determine if there are any further taxes in the invoice record to process in accordance with the aforementioned steps. If there are additional taxes in the invoice record to process, control is transferred to the loop beginning at 708 and processing continues. When there are no more taxes on the invoice to process as determined at 713, the invoice status of the corresponding invoice in the invoices database 255 is marked as closed at 714 and the determination is made at 716 as to whether there is another invoice marked as paid in the invoices database to process. After the final tax of the current invoice being processed is accounted for, the method checks to see if there are additional invoices to be processed at 716. If so, the steps of the method 704 through 716 are repeated for the next invoice. When there are no more invoices to process, the method is complete and exits at 720. In time, when additional invoices are stored into the invoices database 255 and marked as paid, the method is invoked again to process tax payments for the newly paid invoices.

Thus, there is provided a computer-enabled method for dynamic, automated application of taxes to veterinary pharmaceutical and other animal-related product items for sale by a central product provider. There is also provided subsequent recovery of historical tax application information by the central product provider for automated tax determination, crediting and distribution to a veterinary hospital of at least one tax invoiced and paid from a customer wallet database at the sale of the animal-related product Thus, together with the forgoing, all of the aspects of the invention combined comprise the following steps: (a) in a central product provider computer, asynchronously creating and storing in a computer readable medium member account details for a customer identified by a unique customer ID that is associated with a customer profile comprising customer location information and any associated veterinary hospital identified by a unique hospital ID; (b) in the central product provider computer, retrieving in a computer-readable medium at least one per-item tax record, each per-item tax record comprising at least a unique per-item tax ID field, a product ID field, a location code field, a tax amount field and a tax rate field; (c) in the central product provider computer, retrieving in a computer-readable medium at least one per-invoice tax record, each per-invoice tax record comprising at least a per-invoice tax ID field, a location code field, a per-invoice tax amount field and a per-invoice tax rate field; (d) responsive to a request from a customer computer, in a central product provider computer, creating in computer readable memory a temporary invoice record comprising a unique invoice ID, temporarily storing in the invoice record any veterinary hospital ID, the customer ID of the customer making the request, a location code, and providing to the customer computer item product information for at least one item for selection; (e) responsive to a selection from the customer computer, in the central product provider computer, retrieving at least one per-item tax from computer readable medium and temporarily storing in the invoice record a snapshot for subsequent optional recall of product item record information comprising at least: (i) a unique product ID, (ii) the current base price corresponding to the selected item, (iii) at least one per-item tax corresponding to the selected item, the at least one per-item tax comprising a tax ID and a per-item tax amount comprising the sum of at least the following: (a) any per-item tax value obtained from the per-item tax amount field referenced by the location code and the product ID; (b) any per-item tax value obtained by multiplying any associated per-item tax rate from the per-item tax rate field referenced by the location code and the product ID; (iv) an item price total comprising the sum of at least the item current base price and the at least one per-item tax amount; (f) making available for display at the customer computer the selected item information and the corresponding total selected item price; (g) in the central product provider computer, responsive to a confirmation of an intention to purchase the at least one item temporarily stored in the temporary invoice record, retrieving and storing in the invoice record at least one per-invoice tax comprising an associated tax ID and an associated tax amount comprising the sum of at least the following: (i) any per-invoice value obtained from the per-invoice tax amount field referenced by the location code; (ii) any per-invoice value obtained by multiplying any associated tax rate from the per-invoice tax rate field referenced by the location code; (h) calculating and storing in the invoice record an invoice total comprising each product item price total and the at least one per-invoice tax; (i) marking the invoice record as open and transferring the invoice record to an invoices database; (j) retrieving the invoice marked as open into computer readable memory, using the unique customer ID to reference a wallet database with at least one set of credit card processing information for the customer, processing payment of the invoice total using the at least one set of credit card processing information, obtaining approval from the credit card financial institution, marking the invoice as paid; (k) retrieving into a computer-readable medium at least part of a marked paid invoice record from an invoices database and containing a unique invoice ID, a unique customer ID and at least one tax ID and associated tax amount; (l) for each tax ID from the invoice record, using the tax ID to retrieve tax authority information; (m) recording each collected tax amount in a veterinary hospital's, or veterinarian's, ledger; (n) distributing collected tax amounts to the veterinary hospital's account; and (o) marking the invoice as closed.

Collected tax amounts are credited and distributed directly to a veterinary hospital account in accordance with understood and accepted industry practices. A report is also generated that tells the veterinary hospital administrators which taxing authorities are to receive the taxes collected and the amounts due. The actual payment of the tax to the appropriate tax authority is thus left to a hospital administrator or other professional. Alternately, a system of crediting taxing authority accounts on behalf of a veterinary hospital may be employed. In that case, a report would be provided to the veterinary hospital that provides the information necessary for the hospital to report as necessary to each appropriate taxing authority.

The present invention addresses the limitations of prior art manual pharmaceutical and animal product tax application and distribution systems, as well as the limitations of tax systems used by telephone or Internet-based centralized animal pharmacies. With the present invention, a larger centralized pharmacy is enabled to effectively apply, determine and distribute the many per-item and per-invoice taxes to taxing authorities and other regulatory bodies and associated with the sale of a diversity of animal pharmaceuticals and products.

Since each individual regulatory body's taxing or regulatory fee information is able to be stored and changed on the central pharmacy's server system, and since these changes are captured in snapshot fashion for later use with each invoice record as the invoice is made, a historically accurate record of taxes as they are and were applied is created. Therefore, interim changes to the taxes, whether they be per-product-item or per-invoice tax changes, not only take place immediately and immediately reflect associated product price changes before presentation to the customer, but the information is also available for recall by the central product provider to credit and distribute funds to each hospital for remittance to each appropriate taxing authority. Thus the invention enables veterinary hospitals to more effectively participate in the sale of veterinary products to their customers, since the burdensome regulatory aspect of collecting and accounting for taxes is now able to be performed by a central product provider.

Since the veterinary hospital is able to participate effectively in the sale of products to its customers, the hospital is incentivized to build and maintain a good relationship with the centralized product provider/pharmacy. This is not only good for business for each party involved, but this also results in more effective service to animal hospital customers.

The invention provides for allocation, crediting and distribution of taxes based upon updated per-item and per-invoice tax change tracking, whether the sale of veterinary products is to the hospital itself for use on its own account, to a hospital customer who purchases at a point of sale hospital computer terminal, or to a hospital, or veterinarian, customer who purchases at an e-commerce website hosted for the hospital by the central product provider. In this way, the value added service provided by the hospital to its customers helps solidify the relationship between the hospital and its customer.

Since the system of the invention allows centralized processing and payment of tax and other regulatory fees associated with animal product sales at point of sale terminals at hospitals or at a myriad of customer locations via the Internet, the centralized product provider is enabled to make product offerings of automatically and dynamically priced products for sale to customers for a large number of smaller, in many cases, and disparate veterinary treatment centers—effectively enabling them to participate in the sale of animal-related pharmaceuticals and products directly to their customers. This, in turn, positively impacts compliance with veterinary treatment programs.

Since, as shown in FIG. 1c, in accordance with the present invention the veterinarian is conveniently placed at the center of the supply of pharmaceuticals and other products in the processes of the invention, the veterinarian is supported in providing better care to the animal and in enabling better compliance by the animal owner with treatment plans. This coherent, comprehensive, veterinarian-centric method and system of supplying animal-related products to animal owners for administering treatments to their animals fosters appropriate and best practices for practicing veterinarian medicine.

Further, as shown in FIG. 1c, the present invention assists veterinary hospitals in avoiding the erosion of profit margins associated with interim tax increases since the invention enables immediate, real-time, pricing increases associated with tax and regulatory fee increases as shown in rows A, B and C. Conversely, the invention enables the veterinary hospital to avoid overcharging customers where tax and regulatory fees are decreased.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1) A computer-enabled method for dynamic, automated application of taxes to veterinary pharmaceutical and other animal-related product items for sale by a central product provider, wherein said method allows subsequent recovery of historical information regarding details of tax applied to the sale of the animal-related products by the central product provider for subsequent use to credit and distribute taxes collected from sale of the product to taxing authorities, comprising the steps of:
(a) in a central product provider computer, asynchronously creating and storing in a computer readable medium member account details for a customer identified by a unique customer ID that is associated with a customer profile comprising customer location information and any associated veterinary hospital identified by a unique hospital ID;
(b) in the central product provider computer, retrieving in a computer-readable medium at least one per-item tax record, each per-item tax record comprising at least a unique per-item tax ID field, a product ID field, a location code field, a tax amount field and a tax rate field;
(c) responsive to a request from a customer computer, in a central product provider computer, creating in computer readable memory a temporary invoice record comprising a unique invoice ID, temporarily storing in the invoice record any veterinary hospital ID, the customer ID of the customer making the request, a location code, and providing to the customer computer item product information for at least one item for selection;
(d) responsive to a selection from the customer computer, in the central product provider computer, retrieving at least one per-item tax from computer readable medium and temporarily storing in the invoice record a snapshot for subsequent optional recall of product item record information comprising at least:
(i) a unique product ID,
(ii) the current base price corresponding to the selected item,
(iii) at least one per-item tax corresponding to the selected item, the at least one per-item tax comprising a tax ID and a per-item tax amount comprising the sum of at least the following:
(a) any per-item tax value obtained from the per-item tax amount field referenced by the location code and the product ID;
(b) any per-item tax value obtained by multiplying any associated per-item tax rate from the per-item tax rate field referenced by the location code and the product ID;
(iv) an item price total comprising the sum of at least the item current base price and the at least one per-item tax amount; and
(e) making available for display at the customer computer the selected item information and the corresponding total selected item price.

2) The method of claim 1, further comprising the steps of:
(a) in the central product provider computer, retrieving in a computer-readable medium at least one per-invoice tax record, each per-invoice tax record comprising at least a per-invoice tax ID field, a location code field, a per-invoice tax amount field and a per-invoice tax rate field;
(b) in the central product provider computer, responsive to a confirmation of an intention to purchase the at least one item temporarily stored in the temporary invoice record, retrieving and storing in the invoice record at least one per-invoice tax comprising an associated tax ID and an associated tax amount comprising the sum of at least the following:
(i) any per-invoice value obtained from the per-invoice tax amount field referenced by the location code;
(ii) any per-invoice value obtained by multiplying any associated tax rate from the per-invoice tax rate field referenced by the location code;
(c) calculating and storing in the invoice record an invoice total comprising each product item price total and the at least one per-invoice tax; and
(d) marking the invoice record as open and transferring the invoice record to an invoices database.

3) The method of claim 1, wherein the at least one per-item tax comprises at least one of the following federal, state, county, city, and other local animal product sales taxes: nutrition, equipment, prescription, pharmaceutical, non-prescription and over-the-counter.

4) The method of claim 1, wherein said steps of the method are repeated for each item selected for inclusion on the invoice, the method creating an item record temporarily stored in the temporary invoice record for each iteration of the steps of the method.

5) The method of claim 2, further comprising the steps of retrieving the invoice marked as open into computer readable memory, using the unique customer ID to reference a wallet database with at least one set of credit card processing information for the customer, processing payment of the invoice total using the at least one set of credit card processing information to pay the invoice, obtaining approval from the credit card financial institution and marking the invoice as paid.

6) The method of claim 2, wherein said at least one per-invoice tax comprises at least one of the following taxes: federal, state, county, city, and other local animal product sales taxes.

7) The method of claim 1, wherein the central product provider computer comprises a plurality of computers networked via at least one of local network, Internet, wireless network and satellite network.

8) The method of claim 5, wherein the method further comprises automated allocating, crediting and distribution of at least one tax invoiced and paid at sale of an animal product, wherein the at least one tax comprises a tax ID associated with a tax amount stored in an invoice record, further comprising the steps of:
(a) retrieving into a computer-readable medium at least part of a marked paid invoice record from an invoices database and containing a unique invoice ID, a unique customer ID and at least one tax ID and associated tax amount;
(b) for each tax ID from the invoice record, using the tax ID to retrieve tax authority information;
(c) recording each collected tax amount in a veterinary hospital's ledger;
(d) distributing collected tax amounts to the veterinary hospital's account; and
(e) marking the invoice as closed.

9) The method of claim 1, wherein the product ID references a category of products.

10) A computer-enabled method for dynamic, automated application of taxes to veterinary pharmaceutical and other animal-related product items for sale by a central product provider and subsequent recovery of historical tax application information by the central product provider for automated tax determination, crediting and distribution to a veterinary hospital of at least one tax invoiced and paid from a customer wallet database at the sale of the animal-related product, comprising the steps of:
(a) in a central product provider computer, asynchronously creating and storing in a computer readable medium member account details for a customer identified by a unique customer ID that is associated with a customer profile comprising customer location information and any associated veterinary hospital identified by a unique hospital ID;
(b) in the central product provider computer, retrieving in a computer-readable medium at least one per-item tax record, each per-item tax record comprising at least a unique per-item tax ID field, a product ID field, a location code field, a tax amount field and a tax rate field;
(c) in the central product provider computer, retrieving in a computer-readable medium at least one per-invoice tax record, each per-invoice tax record comprising at least a per-invoice tax ID field, a location code field, a per-invoice tax amount field and a per-invoice tax rate field;
(d) responsive to a request from a customer computer, in a central product provider computer, creating in computer readable memory a temporary invoice record comprising a unique invoice ID, temporarily storing in the invoice record any veterinary hospital ID, the customer ID of the customer making the request, a location code, and providing to the customer computer item product information for at least one item for selection;
(e) responsive to a selection from the customer computer, in the central product provider computer, retrieving at least one per-item tax from computer readable medium and temporarily storing in the invoice record a snapshot for subsequent optional recall of product item record information comprising at least:
(i) a unique product ID,
(ii) the current base price corresponding to the selected item,
(iii) at least one per-item tax corresponding to the selected item, the at least one per-item tax comprising a tax ID and a per-item tax amount comprising the sum of at least the following:
(a) any per-item tax value obtained from the per-item tax amount field referenced by the location code and the product ID;
(b) any per-item tax value obtained by multiplying any associated per-item tax rate from the per-item tax rate field referenced by the location code and the product ID;
(iv) an item price total comprising the sum of at least the item current base price and the at least one per-item tax amount;
(f) making available for display at the customer computer the selected item information and the corresponding total selected item price;
(g) in the central product provider computer, responsive to a confirmation of an intention to purchase the at least one item temporarily stored in the temporary invoice record, retrieving and storing in the invoice record at least one per-invoice tax comprising an associated tax ID and an associated tax amount comprising the sum of at least the following:
(i) any per-invoice value obtained from the per-invoice tax amount field referenced by the location code;
(ii) any per-invoice value obtained by multiplying any associated tax rate from the per-invoice tax rate field referenced by the location code;
(h) calculating and storing in the invoice record an invoice total comprising each product item price total and the at least one per-invoice tax;
(i) marking the invoice record as open and transferring the invoice record to an invoices database;
(j) retrieving the invoice marked as open into computer readable memory, using the unique customer ID to reference a wallet database with at least one set of credit card processing information for the customer, processing payment of the invoice total using the at least one set of credit card processing information, obtaining approval from the credit card financial institution, marking the invoice as paid;
(k) retrieving into a computer-readable medium at least part of a marked paid invoice record from an invoices database and containing a unique invoice ID, a unique customer ID and at least one tax ID and associated tax amount;
(l) for each tax ID from the invoice record, using the tax ID to retrieve tax authority information;
(m) recording each collected tax amount in a veterinary hospital's ledger;
(n) distributing collected tax amounts to the veterinary hospital's account; and
(o) marking the invoice as closed.
